(19) United States
(12) Patent Application Publication
(10) Pub. No.: US 2026/0263992 A1
(43) Pub. Date: Sep. 10, 2026

(54) COMPOSITIONS, METHODS, AND SYSTEMS FOR CARBON CAPTURE

(71) Applicants: Upali WEERASOORIYA, Austin, TX (US); Omar Ali Carrasco JAIM, Austin, TX (US); Francisco Javier ARGUELLES VIVAS, Austin, TX (US); BOARD OF REGENTS, THE UNIVERSITY OF TEXAS SYSTEM, Austin, TX (US)

(72) Inventors: Ryosuke OKUNO, Austin, TX (US); Upali WEERASOORIYA, Austin, TX (US); Omar Ali Carrasco JAIM, Austin, TX (US); Francisco Javier ARGUELLES VIVAS, Austin, TX (US)

(21) Appl. No.: 18/873,696

(22) PCT Filed: Jun. 12, 2023
(86) PCT No.: PCT/US2023/025069

§ 371 Date: Dec. 10, 2024

Related U.S. Application Data
(60) Provisional application No. 63/351,429, filed on Jun. 12, 2022.

(51) Int. Cl. B01D 53/14; B01D 53/62; B01D 53/78

(52) U.S. Cl. CPC B01D 53/1493; B01D 53/1475; B01D 53/62; B01D 53/78; B01D 2252/2041; B01D 2252/20431; B01D 2252/20484; B01D 2252/20489; B01D 2252/602; B01D 2257/504; B01D 2258/0283

(57) ABSTRACT

Described herein are methods for capturing an acidic gas from a gas stream. The method can include contacting the gas stream with a capture solution including a gas capture agent and a surfactant. In some embodiments, the method can include contacting the gas stream with a capture solution including a surface-active gas capture agent.

### CROSS-REFERENCE TO RELATED APPLICATIONS

The application claims the benefit of U.S. Provisional Application No. 63/351,429, filed Jun. 12, 2022, which is hereby incorporated herein by reference in its entirety.

### BACKGROUND

Economies have begun transitioning towards less-carbon intensive energy sources for transportation, electricity generation, industrial processes, and heating. While use of renewable energy sources is expected to grow, fossil fuels are expected to remain a major energy source for many years to come. Therefore, carbon capture, utilization, and storage will be a crucial bridging technology in the sustainable transition of energy sources.

Various carbon species can be generated by converting the captured CO₂ from fossil fuel combustion. CO₂ conversion often uses CO₂ at high purity, which requires purification of CO₂ from flue gases. Therefore, conventional CO₂ capture processes use aqueous solution of amines to capture CO₂ in the acid-base reaction and then release the CO₂ at high temperatures while regenerating the amine solvent.

CO₂ is not easy to handle in the carbon value chains, including transportation, storage, and reactions, because it has corrosivity, small solubility in water, and large compressibility. Also, many CO₂ conversion processes do not require CO₂ as a carbon carrier, and some of them are expected to benefit from using aqueous bicarbonate (HCO₃⁻) solution by reducing the energy requirement and cost. Such bicarbonate pathways of CO₂ conversion can employ different types of amines, such as tertiary amines and sterically hindered primary and secondary amines.

Regardless of the reaction product, structural optimization of amine solutions is important for high-throughput efficient CO₂ capture and/or direct conversion processes in the energy transition. This application relates to the compositions, systems, and methods to enhance carbon capture from gas streams.

### SUMMARY

Provided herein are methods for capturing an acidic gas from a gas stream. These methods can include: contacting the gas stream with a capture solution including a gas capture agent and a surfactant. In some aspects, the techniques described herein relate to a method, wherein the gas capture agent includes an amine gas capture agent.

Also, described herein relate to a method for capturing an acidic gas from a gas stream, the method including: contacting the gas stream with a capture solution including a surface active gas capture agent. In some aspects, the techniques described herein relate to a method, wherein the surface active gas capture agent includes a surfactant including an amine moiety.

In some aspects, the techniques described herein relate to a method, wherein the surface active gas capture agent includes a compound defined by Formula II or Formula III

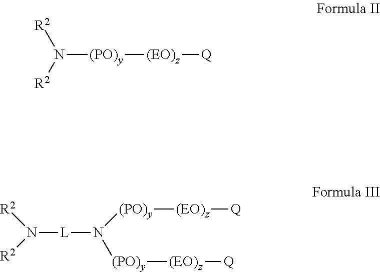

wherein, individually for each occurrence, PO represents —CH₂—CH(methyl)-O—; EO represents —CH₂—CH₂—O—; R² represents, hydrogen, a C₁-C₈ alkyl group, a C₂-C₈ alkenyl group, a C₂-C₈ alkynyl group, an aryl group, an alkylaryl group, or an oxyalkylene group POyEOz-Q; Q is hydrogen; y is an integer from 0 to 60; and z is an integer from 0 to 40, with the proviso that at least one of y and z is greater than 0.

In some aspects, the techniques described herein relate to a method, wherein the surface active gas capture agent includes a compound defined by Formula II or Formula III

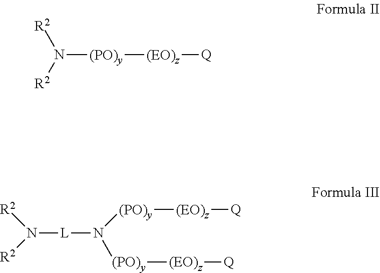

wherein, individually for each occurrence, PO represents —CH₂—CH(methyl)-O—; EO represents —CH₂—CH₂—O—; R² represents, hydrogen, a C₁-C₈ alkyl group, a C₂-C₈ alkenyl group, a C₂-C₈ alkynyl group, an aryl group, an alkylaryl group or oxyalkylene group POyEOz-Q; Q is hydrogen; y is an integer from 0 to 60; and z is an integer from 0 to 40.

In some aspects, the techniques described herein relate to a method, wherein the capture solution further includes a surfactant. In some aspects, the techniques described herein relate to a method, wherein the surfactant includes a non-ionic surfactant. In some aspects, the techniques described herein relate to a method, wherein the surfactant includes an alcohol alkoxylate. In some aspects, the techniques described herein relate to a method, wherein the alcohol alkoxylate includes at least one propoxy segment.

In some aspects, the techniques described herein relate to a method, wherein the surfactant is defined by Formula I

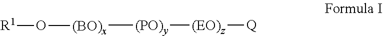

wherein BO represents —CH₂—CH(ethyl)-O— and/or —CH₂CH(—)CH(O—)CH₂—; PO represents —CH₂—CH(methyl)-O—; EO represents —CH₂—CH₂—O—; R¹ represents a C₈-C₃₂ alkyl group, a C₈-C₃₂ alkenyl group, a C₈-C₃₂ alkynyl group, an aryl group, or an alkylaryl group; Q is hydrogen; x is an integer from 0 to 10; y is an integer from 0 to 40; and z is an integer from 0 to 40, with the proviso that at least one of x, y, and z is greater than 0.

In some aspects, the techniques described herein relate to a method, wherein the surfactant is defined by Formula IA

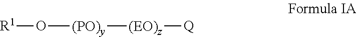

wherein BO represents —CH₂—CH(ethyl)-O— and/or —CH₂CH(—)CH(O—)CH₂—; PO represents —CH₂—CH(methyl)-O—; EO represents —CH₂—CH₂—O—; R¹ represents a C₈-C₃₂ alkyl group, a C₈-C₃₂ alkenyl group, a C₈-C₃₂ alkynyl group, an aryl group, or an alkylaryl group; Q is hydrogen; y is an integer from 1 to 40; and z is an integer from 1 to 40.

In some aspects, the techniques described herein relate to a method, wherein the capture solution includes an aqueous solution.

In some aspects, the techniques described herein relate to a method, wherein the gas stream includes one or more gases chosen from a flue gas, a natural gas, a hydrogen gas, and a synthesis gas.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 is a schematic representation of the proposed CO₂ capture into bicarbonate pathway for CCU technologies.

FIG. 2 illustrates chemical structures of the amines described herein.

FIGS. 3A-3B is a schematic representation of (3A) CO₂ absorption experimental setup, and (3B) CO₂ loading capacity determination.

FIGS. 4A-4B show graphs of (4A) CO₂ capture capacity, and (4B) CO₂ loading profile of 0.116 mol/L DMAPA.

FIGS. 5A-5B show graphs (5A) CO₂ absorption capacity, and (5B) CO₂ loading profile of 0.116 mol/L DMAPA-xPO (x=4, 6, 8, 12).

FIG. 6 shows a graph of PO group effects on surface tension and CO₂ loading rate of 0.116 mol/L DMAPA-xPO (x=4, 6, 8, 12).

FIGS. 7A-7B show graphs of (7A) CO₂ loading profile of 0.116 mol/L DMAPA+0.01 mol/L glycerol-xPO (x=4, 12, 30), and (7B) CO₂ loading overview for DMAPA+glycerol-xPO tests. C1 is defined as 0.116 mol/L DMAPA-xPO (x=4, 6, 8, 12) experiments; C′1 is defined as 0.116 mol/L DMAPA+0.01 mol/L glycerol-xPO (x=4, 12, 30) experiments; C′2 is defined as 0.25 mol/L DMAPA experiments.

FIGS. 8A-8B show graphs (8A) ¹³C NMR spectra of 0.25 mol/L DMAPA solution during CO₂ capture; (8B) Concentration profile of carbamate/bicarbonate species detected during CO₂ capture.

FIGS. 9A-9B show (9A) ¹³C NMR spectra of 0.25 mol/L DMAPA-6PO solution during CO₂ capture; (9B) Bicarbonate concentration profile during CO₂ capture.

FIG. 10 shows a graph of the relationship between CO₂ absorption capacity and bicarbonate production for DMAPA and DMAPA-xPO (x=4, 6, 8, 12) samples.

FIG. 11A-11C shows proposed pathways for CO₂ reaction with DMAPA-xPO in aqueous solution: (11A) CO₂ dissolution into H₂CO₃ in aqueous phase; (11B) DMAPA-xPO reaction with H₂CO₃ to produce HCO₃⁻; and (11C) H₂CO₃ deprotonation to form HCO₃⁻.

FIG. 12 is an illustration of the experimental set up.

FIG. 13A-13B are graphs showing the effects of surfactant on DI water (13A) DI water control and (13B) 2EH-7PO-8EO.

FIG. 14A-14C show a graph of the AMP effects on CO₂ capture (14A). (14B) is a 13C HMR spectra at different stages in the reaction and (14C) is reaction scheme for each stage shown in FIG. 14A.

FIG. 15A-15B show the MEA effects on CO₂ capture (15B) and (15A) is a reaction scheme for each stage shown in FIG. 15B.

FIG. 16A-16B are graphs showing the surfactant effects on amine solutions (16A) shows the kinetic reaction rate for AMP and surfactant and (16B) shows the kinetic reaction rate for MEA and surfactant.

FIG. 17A-17B are graphs showing (17A) CO₂ capture amount for AMP and MEA with and without surfactants and (17B) bicarbonate generation stage (B2) for AMP and MEA with and without surfactants.

FIG. 18 shows exemplary structures of surface-active amines described herein.

FIG. 19A-19C are graphs showing (19A) the kinetic reaction rate for DMAPA-4PO, (19B) the kinetic reaction rate for DMAPA-10PO, and (19C) the CO₂ capture amount for DMAPA-4PO, DMAPA-10PO, and AMP.

FIG. 20A-20B shows (20A) ¹³C NMR spectra of bicarbonate solution at different concentrations, and (20B) calibration curve from linear adjustment between NMR peak area and bicarbonate concentration.

FIG. 21A-21B shows (21A) pH profile, and (21B) CO₂ loading rate determination for 0.116 mol/L DMAPA.

FIG. 22 shows extended CO₂ loading profile of 0.116 mol/L DMAPA-xPO (x=4, 6, 8, 12).

FIG. 23A-23D shows CO₂ loading rate determination of 0.116 mol/L (23A) DMAPA-4PO, (23B) DMAPA-6PO, (23C) DMAPA-8PO, and (23D) DMAPA-12PO.

FIG. 24 shows CO₂ absorption capacity of 0.116 mol/L DMAPA+0.01 mol/L glycerol-xPO (x=4, 12, 30).

FIG. 25A-25C shows ¹³C NMR spectra of 0.25 mol/L (25A) DMAPA-4PO, (25B) DMAPA-8PO, and (25C) DMAPA-12PO solution during CO₂ capture.

FIG. 26 shows ¹³C NMR spectra of 0.25 mol/L DMAPA and DMAPA-6PO solution after 80 min of CO₂ capture reaction.

FIG. 27A-27E shows bicarbonate generation profiles of 0.25 mol/L (27A) DMAPA, (27B) DMAPA-4PO, (27C) DMAPA-6PO, (27D) DMAPA-8PO, and (27E) DMAPA-12PO.

FIG. 28 shows PO groups' relationship with CO₂ loading, bicarbonate production, and bicarbonate average generation rate.

Like reference symbols in the various drawings indicate like elements.

### DETAILED DESCRIPTION

A number of embodiments of the disclosure have been described. Nevertheless, it will be understood that various modifications may be made without departing from the spirit and scope of the invention. Accordingly, other embodiments are within the scope of the following claims.

### Definitions

To facilitate understanding of the disclosure set forth herein, a number of terms are defined below. Unless defined otherwise, all technical and scientific terms used herein generally have the same meaning as commonly understood by one of ordinary skill in the art to which this disclosure belongs. Publications cited herein and the materials for which they are cited are specifically incorporated by reference.

### General Definitions

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Other than where noted, all numbers expressing quantities of ingredients, reaction conditions, geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Accordingly, these terms are intended to not only cover the recited element(s) or step(s), but may also include other elements or steps not expressly recited. Furthermore, as used herein, the use of the terms “a”, “an”, and “the” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. A range may be construed to include the start and the end of the range. For example, a range of 10% to 20% (i.e., range of 10%-20%) can includes 10% and also includes 20%, and includes percentages in between 10% and 20%, unless explicitly stated otherwise herein.

As used herein, the terms “may,” “optionally,” and “may optionally” are used interchangeably and are meant to include cases in which the condition occurs as well as cases in which the condition does not occur. Thus, for example, the statement that a formulation “may include an excipient” is meant to include cases in which the formulation includes an excipient as well as cases in which the formulation does not include an excipient.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if a composition is described herein as including a component of type A, a component of type B, a component of type C, or any combination thereof, it is understood that this phrase describes all of the various individual and collective combinations and permutations of these components. For example, in some embodiments, the composition described by this phrase could include only a component of type A. In some embodiments, the composition described by this phrase could include only a component of type B. In some embodiments, the composition described by this phrase could include only a component of type C. In some embodiments, the composition described by this phrase could include a component of type A and a component of type B. In some embodiments, the composition described by this phrase could include a component of type A and a component of type C. In some embodiments, the composition described by this phrase could include a component of type B and a component of type C. In some embodiments, the composition described by this phrase could include a component of type A, a component of type B, and a component of type C. In some embodiments, the composition described by this phrase could include two or more components of type A (e.g., A1 and A2). In some embodiments, the composition described by this phrase could include two or more components of type B (e.g., B1 and B2). In some embodiments, the composition described by this phrase could include two or more components of type C (e.g., C1 and C2). In some embodiments, the composition described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the composition described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the composition described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

### Chemical Definitions

Terms used herein will have their customary meaning in the art unless specified otherwise. The organic moieties mentioned when defining variable positions within the general formulae described herein (e.g., the term “halogen”) are collective terms for the individual substituents encompassed by the organic moiety. Ph in Formula I refers to a phenyl group.

The prefix Cn-Cm preceding a group or moiety indicates, in each case, the possible number of carbon atoms in the group or moiety that follows.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, heteroatoms present in a compound or moiety, such as nitrogen, can have hydrogen substituents and/or any permissible substituents of organic compounds described herein which satisfy the valency of the heteroatom. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound (e.g., a compound that does not spontaneously undergo transformation such as by rearrangement, cyclization, elimination, etc.

The term “optionally substituted,” as used herein, means that substitution with an additional group is optional and therefore it is possible for the designated atom to be unsubstituted. Thus, by use of the term “optionally substituted” the disclosure includes examples where the group is substituted and examples where it is not.

“Z¹,” “Z²,” “Z³,” and “Z⁴” are used herein as generic symbols to represent various specific substituents. These symbols can be any substituent, not limited to those disclosed herein, and when they are defined to be certain substituents in one instance, they can, in another instance, be defined as some other substituents.

As used herein, the term “alkyl” refers to saturated, straight-chained or branched saturated hydrocarbon moieties. Unless otherwise specified, C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄)alkyl groups are intended. Examples of alkyl groups include methyl, ethyl, propyl, 1-methyl-ethyl, butyl, 1-methyl-propyl, 2-methyl-propyl, 1,1-dimethyl-ethyl, pentyl, 1-methyl-butyl, 2-methyl-butyl, 3-methyl-butyl, 2,2-dimethyl-propyl, 1-ethyl-propyl, hexyl, 1,1-dimethyl-propyl, 1,2-dimethyl-propyl, 1-methyl-pentyl, 2-methyl-pentyl, 3-methyl-pentyl, 4-methyl-pentyl, 1,1-dimethyl-butyl, 1,2-dimethyl-butyl, 1,3-dimethyl-butyl, 2,2-dimethyl-butyl, 2,3-dimethyl-butyl, 3,3-dimethyl-butyl, 1-ethyl-butyl, 2-ethyl-butyl, 1,1,2-trimethyl-propyl, 1,2,2-trimethyl-propyl, 1-ethyl-1-methyl-propyl, and 1-ethyl-2-methyl-propyl. Alkyl substituents may be unsubstituted or substituted with one or more chemical moieties. The alkyl group can be substituted with one or more groups including, but not limited to, hydroxy, halogen, acyl, alkyl, alkoxy, alkenyl, alkynyl, aryl, heteroaryl, acyl, aldehyde, amino, carboxylic acid, ester, ether, ketone, nitro, silyl, sulfo-oxo, sulfonyl, sulfone, sulfoxide, thiosulfonate (e.g., —SSO₂Ra), or thiol, as described below, provided that the substituents are sterically compatible and the rules of chemical bonding and strain energy are satisfied. The alkyl group can also include one or more heteroatoms (e.g., from one to three heteroatoms) incorporated within the hydrocarbon moiety. Examples of heteroatoms include, but are not limited to, nitrogen, oxygen, sulfur, and phosphorus.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” specifically refers to an alkyl group that is substituted with one or more halides (halogens; e.g., fluorine, chlorine, bromine, or iodine). The term “alkoxyalkyl” specifically refers to an alkyl group that is substituted with one or more alkoxy groups, as described below. The term “alkylamino” specifically refers to an alkyl group that is substituted with one or more amino groups, as described below, and the like. The term “alkylthiol” specifically refers to an alkyl group that is substituted with one or more thiol groups, as described below, and the like. When “alkyl” is used in one instance and a specific term such as “alkylalcohol” is used in another, it is not meant to imply that the term “alkyl” does not also refer to specific terms such as “alkylalcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

As used herein, the term “alkenyl” refers to unsaturated, straight-chained, or branched hydrocarbon moieties containing a double bond. Unless otherwise specified, C₂-C₂₄ (e.g., C₂-C₂₂, C₂-C₂₀, C₂-C₁₈, C₂-C₁₆, C₂-C₁₄, C₂-C₁₂, C₂-C₁₀, C₂-C₈, C₂-C₆, C₂-C₄)alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure —CH═CH—CH₃; and 2-propenyl refers to a group with the structure —CH₂—CH—CH₂. Asymmetric structures such as (Z¹Z²)C═C(Z³Z⁴) are intended to include both the E and Z isomers. This can be presumed in structural formulae herein wherein an asymmetric alkene is present, or it can be explicitly indicated by the bond symbol C═C. Alkenyl substituents may be unsubstituted or substituted with one or more chemical moieties. Examples of suitable substituents include, for example, alkyl, halogenated alkyl, alkoxy, alkenyl, alkynyl, aryl, heteroaryl, acyl, aldehyde, amino, carboxylic acid, ester, ether, halide, hydroxy, ketone, nitro, silyl, sulfo-oxo, sulfonyl, sulfone, sulfoxide, thiosulfonate (e.g., —SSO₂Ra), or thiol, as described below, provided that the substituents are sterically compatible and the rules of chemical bonding and strain energy are satisfied.

As used herein, the term “alkynyl” represents straight-chained or branched hydrocarbon moieties containing a triple bond. Unless otherwise specified, C₂-C₂₄ (e.g., C₂-C₂₂, C₂-C₂₀, C₂-C₁₈, C₂-C₁₆, C₂-C₁₄, C₂-C₁₂, C₂-C₁₀, C₂-C₈, C₂-C₆, C₂-C₄)alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, 1-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, and 1-ethyl-1-methyl-2-propynyl. Alkynyl substituents may be unsubstituted or substituted with one or more chemical moieties. Examples of suitable substituents include, for example, alkyl, halogenated alkyl, alkoxy, alkenyl, alkynyl, aryl, heteroaryl, acyl, aldehyde, amino, carboxylic acid, ester, ether, halide, hydroxy, ketone, nitro, silyl, sulfo-oxo, sulfonyl, sulfone, sulfoxide, thiosulfonate (e.g., —SSO₂Ra), or thiol, as described below.

As used herein, the term “aryl,” as well as derivative terms such as aryloxy, refers to groups that include a monovalent aromatic carbocyclic group of from 3 to 20 carbon atoms. Aryl groups can include a single ring or multiple condensed rings. In some embodiments, aryl groups include C₆-C₁₀ aryl groups. Examples of aryl groups include, but are not limited to, phenyl, biphenyl, naphthyl, tetrahydronaphthyl, phenylcyclopropyl, and indanyl. In some embodiments, the aryl group can be a phenyl, indanyl or naphthyl group. The term “heteroaryl” is defined as a group that contains an aromatic group that has at least one heteroatom incorporated within the ring of the aromatic group. Examples of heteroatoms include, but are not limited to, nitrogen, oxygen, sulfur, and phosphorus. The term “non-heteroaryl,” which is included in the term “aryl,” defines a group that contains an aromatic group that does not contain a heteroatom. The aryl or heteroaryl substituents may be unsubstituted or substituted with one or more chemical moieties. Examples of suitable substituents include, for example, alkyl, halogenated alkyl, alkoxy, alkenyl, alkynyl, aryl, heteroaryl, acyl, aldehyde, amino, carboxylic acid, cycloalkyl, ester, ether, halide, hydroxy, ketone, nitro, silyl, sulfo-oxo, sulfonyl, sulfone, sulfoxide, or thiol as described herein. The term “biaryl” is a specific type of aryl group and is included in the definition of aryl. Biaryl refers to two aryl groups that are bound together via a fused ring structure, as in naphthalene, or are attached via one or more carbon-carbon bonds, as in biphenyl.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, acyl, aldehyde, amino, carboxylic acid, ester, ether, halide, hydroxy, ketone, nitro, silyl, sulfo-oxo, sulfonyl, sulfone, sulfoxide, or thiol as described herein.

The term “cycloalkenyl” as used herein is a non-aromatic carbon-based ring composed of at least three carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The term “heterocycloalkenyl” is a type of cycloalkenyl group as defined above, and is included within the meaning of the term “cycloalkenyl,” where at least one of the carbon atoms of the ring is substituted with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, acyl, aldehyde, amino, carboxylic acid, ester, ether, halide, hydroxy, ketone, nitro, silyl, sulfo-oxo, sulfonyl, sulfone, sulfoxide, or thiol as described herein.

The term “cyclic group” is used herein to refer to either aryl groups, non-aryl groups (i.e., cycloalkyl, heterocycloalkyl, cycloalkenyl, and heterocycloalkenyl groups), or both. Cyclic groups have one or more ring systems that can be substituted or unsubstituted. A cyclic group can contain one or more aryl groups, one or more non-aryl groups, or one or more aryl groups and one or more non-aryl groups.

As used herein, “heteroaryl” refers to a monocyclic or polycyclic aromatic heterocycle having at least one heteroatom ring member selected from sulfur, oxygen, and nitrogen. In some embodiments, the heteroaryl ring has 1, 2, 3, or 4 heteroatom ring members independently selected from nitrogen, sulfur and oxygen. In some embodiments, any ring-forming N in a heteroaryl moiety can be an N-oxide. In some embodiments, the heteroaryl has 5-10 ring atoms and 1, 2, 3 or 4 heteroatom ring members independently selected from nitrogen, sulfur and oxygen. In some embodiments, the heteroaryl has 5-6 ring atoms and 1 or 2 heteroatom ring members independently selected from nitrogen, sulfur and oxygen. In some embodiments, the heteroaryl is a five-membered or six-membered heteroaryl ring. A five-membered heteroaryl ring is a heteroaryl with a ring having five ring atoms wherein one or more (e.g., 1, 2, or 3) ring atoms are independently selected from N, O, and S. Exemplary five-membered ring heteroaryls are thienyl, furyl, pyrrolyl, imidazolyl, thiazolyl, oxazolyl, pyrazolyl, isothiazolyl, isoxazolyl, 1,2,3-triazolyl, tetrazolyl, 1,2,3-thiadiazolyl, 1,2,3-oxadiazolyl, 1,2,4-triazolyl, 1,2,4-thiadiazolyl, 1,2,4-oxadiazolyl, 1,3,4-triazolyl, 1,3,4-thiadiazolyl, and 1,3,4-oxadiazolyl. A six-membered heteroaryl ring is a heteroaryl with a ring having six ring atoms wherein one or more (e.g., 1, 2, or 3) ring atoms are independently selected from N, O, and S. Exemplary six-membered ring heteroaryls are pyridyl, pyrazinyl, pyrimidinyl, triazinyl and pyridazinyl.

As used herein, “heterocycloalkyl” refers to non-aromatic monocyclic or polycyclic heterocycles having one or more ring-forming heteroatoms selected from O, N, or S. Included in heterocycloalkyl are monocyclic 4-, 5-, 6-, and 7-membered heterocycloalkyl groups. Heterocycloalkyl groups can also include spirocycles. Example heterocycloalkyl groups include pyrrolidin-2-one, 1,3-isoxazolidin-2-one, pyranyl, tetrahydropuran, oxetanyl, azetidinyl, morpholino, thiomorpholino, piperazinyl, tetrahydrofuranyl, tetrahydrothienyl, piperidinyl, pyrrolidinyl, isoxazolidinyl, isothiazolidinyl, pyrazolidinyl, oxazolidinyl, thiazolidinyl, imidazolidinyl, azepanyl, benzazapene, and the like. Ring-forming carbon atoms and heteroatoms of a heterocycloalkyl group can be optionally substituted by oxo or sulfido (e.g., C(O), S(O), C(S), or S(O)₂, etc.). The heterocycloalkyl group can be attached through a ring-forming carbon atom or a ring-forming heteroatom. In some embodiments, the heterocycloalkyl group contains 0 to 3 double bonds. In some embodiments, the heterocycloalkyl group contains 0 to 2 double bonds. Also included in the definition of heterocycloalkyl are moieties that have one or more aromatic rings fused (i.e., having a bond in common with) to the cycloalkyl ring, for example, benzo or thienyl derivatives of piperidine, morpholine, azepine, etc. A heterocycloalkyl group containing a fused aromatic ring can be attached through any ring-forming atom including a ring-forming atom of the fused aromatic ring. In some embodiments, the heterocycloalkyl has 4-10, 4-7 or 4-6 ring atoms with 1 or 2 heteroatoms independently selected from nitrogen, oxygen, or sulfur and having one or more oxidized ring members.

At certain places, the definitions or embodiments refer to specific rings (e.g., an azetidine ring, a pyridine ring, etc.). Unless otherwise indicated, these rings can be attached to any ring member provided that the valency of the atom is not exceeded. For example, an azetidine ring may be attached at any position of the ring, whereas a pyridin-3-yl ring is attached at the 3-position.

The term “acyl” as used herein is represented by the formula —C(O)Z¹ where Z¹ can be a hydrogen, hydroxyl, alkoxy, alkyl, halogenated alkyl, alkenyl, alkynyl, aryl, heteroaryl, cycloalkyl, cycloalkenyl, heterocycloalkyl, or heterocycloalkenyl group described above. As used herein, the term “acyl” can be used interchangeably with “carbonyl.” Throughout this specification “C(O)” or “CO” is a short hand notation for C═O.

As used herein, the term “alkoxy” refers to a group of the formula Z¹—O—, where Z¹ is unsubstituted or substituted alkyl as defined above. Unless otherwise specified, alkoxy groups wherein Z¹ is a C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, C₁-C₄)alkyl group are intended. Examples include methoxy, ethoxy, propoxy, 1-methyl-ethoxy, butoxy, 1-methyl-propoxy, 2-methyl-propoxy, 1,1-dimethyl-ethoxy, pentoxy, 1-methyl-butyloxy, 2-methyl-butoxy, 3-methyl-butoxy, 2,2-di-methyl-propoxy, 1-ethyl-propoxy, hexoxy, 1,1-dimethyl-propoxy, 1,2-dimethyl-propoxy, 1-methyl-pentoxy, 2-methyl-pentoxy, 3-methyl-pentoxy, 4-methyl-penoxy, 1,1-dimethyl-butoxy, 1,2-dimethyl-butoxy, 1,3-dimethyl-butoxy, 2,2-dimethyl-butoxy, 2,3-dimethyl-butoxy, 3,3-dimethyl-butoxy, 1-ethyl-butoxy, 2-ethylbutoxy, 1,1,2-trimethyl-propoxy, 1,2,2-trimethyl-propoxy, 1-ethyl-1-methyl-propoxy, and 1-ethyl-2-methyl-propoxy.

The term “aldehyde” as used herein is represented by the formula —C(O)H.

The terms “amine” or “amino” as used herein are represented by the formula —NZ¹Z², where Z¹ and Z² can each be substitution group as described herein, such as hydrogen, an alkyl, halogenated alkyl, alkenyl, alkynyl, aryl, heteroaryl, cycloalkyl, cycloalkenyl, heterocycloalkyl, or heterocycloalkenyl group described above. “Amido” is —C(O)NZ¹Z².

The term “carboxylic acid” as used herein is represented by the formula —C(O)OH. A “carboxylate” or “carboxyl” group as used herein is represented by the formula —C(O)O⁻.

The term “ester” as used herein is represented by the formula —OC(O)Z¹ or —C(O)OZ¹, where Z¹ can be an alkyl, halogenated alkyl, alkenyl, alkynyl, aryl, heteroaryl, -cycloalkyl, cycloalkenyl, heterocycloalkyl, or heterocycloalkenyl group described above.

The term “ether” as used herein is represented by the formula Z¹OZ², where Z¹ and Z² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “ketone” as used herein is represented by the formula Z¹C(O)Z², where Z¹ and Z² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “halide” or “halogen” or “halo” as used herein refers to fluorine, chlorine, bromine, and iodine.

The term “hydroxyl” as used herein is represented by the formula —OH.

The term “nitro” as used herein is represented by the formula —NO₂.

The term “silyl” as used herein is represented by the formula —SiZ¹Z²Z³, where Z¹, Z², and Z³ can be, independently, hydrogen, alkyl, halogenated alkyl, alkoxy, alkenyl, alkynyl, aryl, heteroaryl, cycloalkyl, cycloalkenyl, heterocycloalkyl, or heterocycloalkenyl group described above.

The term “sulfonyl” is used herein to refer to the sulfo-oxo group represented by the formula —S(O)₂Z¹, where Z¹ can be hydrogen, an alkyl, halogenated alkyl, alkenyl, alkynyl, aryl, heteroaryl, cycloalkyl, cycloalkenyl, heterocycloalkyl, or heterocycloalkenyl group described above.

The term “sulfonylamino” or “sulfonamide” as used herein is represented by the formula —S(O)₂NH—.

The term “thiol” as used herein is represented by the formula —SH.

The term “thio” as used herein is represented by the formula —S—.

As used herein, Me refers to a methyl group; OMe refers to a methoxy group; and i-Pr refers to an isopropyl group.

“R¹,” “R²,” “R³,” “Rⁿ,” etc., where n is some integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an amine group, an alkyl group, a halide, and the like. Depending upon the groups that are selected, a first group can be incorporated within second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

The term “substituted” refers to a molecule wherein at least one hydrogen atom is replaced with a substituent. When substituted, one or more of the groups are “substituents.” The molecule can be multiply substituted. In the case of an oxo substituent (“═O”), two hydrogen atoms are replaced. Example substituents within this context can include halogen, hydroxy, alkyl, alkoxy, nitro, cyano, oxo, carbocyclyl, carbocycloalkyl, heterocarbocyclyl, heterocarbocycloalkyl, aryl, arylalkyl, heteroaryl, heteroarylalkyl, —NRaRb, —NRaC(═O)Rb, —NRaC(═O)NRaNRb, —NRaC(═O)ORb, —NRaSO₂Rb, —C(═O)Ra, —C(═O)ORa, —C(═O)NRaRb, —OC(═O)NRaRb, —ORa, —SRa, —SORa, —S(═O)₂Ra, —OS(═O)₂Ra and —S(═O)₂ORa. Ra and Rb in this context can be the same or different and independently hydrogen, halogen hydroxyl, alkyl, alkoxy, alkyl, amino, alkylamino, dialkylamino, carbocyclyl, carbocycloalkyl, heterocarbocyclyl, heterocarbocycloalkyl, aryl, arylalkyl, heteroaryl, heteroarylalkyl.

Unless stated to the contrary, a formula with chemical bonds shown only as solid lines and not as wedges or dashed lines contemplates each possible stereoisomer or mixture of stereoisomer (e.g., each enantiomer, each diastereomer, each meso compound, a racemic mixture, or scalemic mixture).

### Capture Solutions

Described herein are capture solutions in which a surfactant (e.g., a nonionic surfactant such as an alcohol alkoxylate) is combined with a gas capture agent (e.g., an amine gas capture agent such as MEA, MDEA, and/or AMP, to enhance the CO₂ capacity and reaction rate of the capture solution.

Also described herein are capture solutions comprising a surface-active gas capture agent (e.g., a surfactant comprising an amine moiety). The surface-active character of this active agent can improve the CO₂ capacity and reaction rate of the capture solution as compared to conventional amine capture agents such as MEA. Optionally, one or more additional surfactants can be added to these capture solutions to further enhance the CO₂ capacity and reaction rate of the capture solution.

### Gas Capture Agent

The gas capture agent can include, but is not limited to, an amine gas capture agent such as a monoamine, a diamine, or a polyamine. In some embodiments, the amine gas capture agent can include a monoamine. In some embodiments, the amine gas capture agent can include a diamine. In some embodiments, the amine gas capture agent can include a polyamine. In some embodiments, the amine gas capture agent can include a tertiary amine or a sterically hindered amine. In some embodiments, the amine gas capture agent can include a tertiary amine. In some embodiments, the amine gas capture agent can include a sterically hindered amine.

In some embodiments, the gas capture agent can include, but is not limited to, methylamine, ethylamine, propylamine, iso-propylamine, butylamine, iso-butylamine, sec-butylamine, tert-butylamine, pentylamine, iso-pentylamine, sec-pentylamine, tert-pentylamine, hexylamine, iso-hexylamine, sec-hexylamine, tert-hexylamine, ethylenediamine, (2-methylbutyl)amine, 2-aminopentane, 3-(tert-butoxy) propylamine, 2-amino-6-methylheptane, 1-ethylpropylamine dimethylamine, diethylamine, dipropylamine, dibutylamine, dipentylamine, dihexylamine, N-ethylmethylamine, N-isopropylmethylamine, N-butylmethylamine, N-ethylisopropylamine, N-tert-butylmethylamine, N-ethylbutylamine, 3-isopropoxypropylamine, chloro(diethylamino)dimethylsilane, 2,2′-(ethylenedioxy)bis(ethylamine), 1,3-bis(chloromethyl)-1,1,3,3-tetramethyldisilazane, N-tert-butylisopropylamine, N,N-diethyltrimethylsilylamine, di-sec-butylamine, trimethylamine, triethylamine, tripropylamine, tributylamine, dimethylpropylamine, diethylpropylamine, N,N-diisopropylmethylamine, N-ethyldiisopropylamine, N,N-dimethylethylamine, N,N-diethylbutylamine, 1,2-dimethylpropylamine, N,N-diethylmethylamine, N,N-dimethylisopropylamine, 1,3-dimethylbutylamine, 3,3-dimethylbutylamine, N,N-dimethylbutylamine, tetramethylethylenediamine (TMEDA), tetraethylmethanediamine (TEMDA), tetramethylmethanediamine (TMMDA), tetramethyl-1,3-diaminopropane (TMPDA) or triethylamine (TEA), monoethanolamine (MEA), diethanolamine (DEA), N-methyldiethanolamine (MDEA), 2-diethylaminoethanol (DEAE), 3-(diethylamino)-1,2-propanediol (DAPD) or 2-amino-2-methyl propan-1-ol (AMP), piperazine (PZ), morpholine, piperidine, pyrrolidine, 1,8-diazabicyclo[5.4.0]undec-7-ene (DBU), glycine, or a combination thereof.

In some embodiments, the gas capture agent can be present in the capture solution in an amount of at least 0.5% by weight, based on the total weight of the capture solution (e.g., at least 1%, at least 2%, at least 3%, or at least 4%).

In some embodiments, the gas capture agent can be present in the capture solution in an amount of 5% by weight or less (e.g., 4% or less, 3% or less, 2% or less, or 1% or less).

The gas capture agent can be present in the capture solution in an amount ranging from any of the minimum values described above to any of the maximum values described above. For examples, in some embodiments, the gas capture agent can be present in the capture solution in an amount of from 0.5% to 5% by weight, based on the total weight of the capture solution (e.g., from 0.5% to 4% by weight, from 0.5% to 3% by weight, from 0.5% to 2% by weight, from 0.5% to 1% by weight, from 1% to 5% by weight, from 1% to 4% by weight, from 1% to 3% by weight, from 1% to 2% by weight, from 2% to 5% by weight, from 2% to 4% by weight, from 2% to 3% by weight, from 3% to 5% by weight, from 3% to 4% by weight, or from 4% to 5% by weight).

### Surface Active Gas Captures Agent

The surface-active gas capture agent can include a surfactant comprising an amine moiety. In some embodiments, the amine moiety can include a tertiary amine moiety, or a sterically hindered amine moiety. In some embodiments, the surface-active gas capture agent can include a surfactant including a tertiary amine moiety. In some embodiments, the surface-active gas capture agent can include a surfactant including a sterically hindered amine moiety.

In some embodiments, the surface-active gas capture agent can include a compound defined by Formula II or Formula III

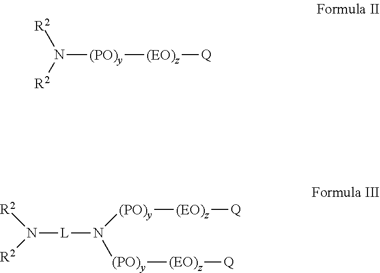

wherein, individually for each occurrence,
   PO represents —CH₂—CH(methyl)-O—;
   EO represents —CH₂—CH₂—O—;
   R² represents, hydrogen, a C₁-C₈alkyl group, a C₂-C₈ alkenyl group, a C₂-C₈ alkynyl group, an aryl group, an alkylaryl group, or oxyalkylene group POyEOz-Q;
   Q is hydrogen;
   y is an integer from 0 to 60; and
   z is an integer from 0 to 40,
with the proviso that at least one of y and z is greater than 0.

In some embodiments, the surface-active gas capture agent can include a compound defined by Formula II

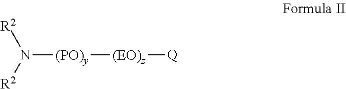

wherein, individually for each occurrence,
   PO represents —CH₂—CH(methyl)-O—;
   EO represents —CH₂—CH₂—O—;
   R² represents, hydrogen, a C₁-C₈ alkyl group, a C₂-C₈ alkenyl group, a C₂-C₈ alkynyl group, an aryl group, an alkylaryl group, or oxyalkylene group POyEOz-Q;
   Q is hydrogen;
   y is an integer from 0 to 60; and
   z is an integer from 0 to 40,
with the proviso that at least one of y and z is greater than 0.

In some embodiments, the surface-active gas capture agent can include a compound defined by Formula III

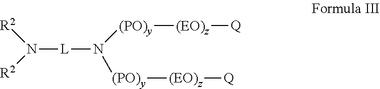

wherein, individually for each occurrence,
   PO represents —CH₂—CH(methyl)-O—;
   EO represents —CH₂—CH₂—O—;
   R² represents, hydrogen, a C₁-C₈alkyl group, a C₂-C₈ alkenyl group, a C₂-C₈ alkynyl group, an aryl group, an alkylaryl group, or oxyalkylene group POyEOz-Q;
   Q is hydrogen;
   y is an integer from 0 to 60; and
   z is an integer from 0 to 40,
with the proviso that at least one of y and z is greater than 0.

In some embodiments, R² can be hydrogen. In some embodiments, R² can be a C₁-C₈ alkyl group. In some embodiments, R² can be a C₂-C₈ alkenyl group. In some embodiments, R² can be a C₂-C₈ alkynyl group. In some embodiments, R² can be an aryl group. In some embodiments, R² can be an alkylaryl group. In some embodiments, R² can be a methyl group.

In some embodiments, L can be a C₁-C₈ alkyl, a C₂-C₈ alkenyl, a C₂-C₈ alkynyl. In some embodiments, L can be a C₁-C₈alkyl. In some embodiment, L can be a C₃ alkyl.

In some embodiments, y can be 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40.

In some embodiments, y can be at least 0.1 (e.g., at least 1, at least 5, at least 10, at least 15, at least 20, at least 25, at least 30, or at least 35). In some embodiments, y can be 40 or less (e.g., 35 or less, 30 or less, 25 or less, 20 or less, 15 or less, 10 or less, 5 or less, or 1 or less).

The y can be an integer ranging from any of the minimum values described above to any of the maximum values described above. For example, in some embodiments, y can be an integer from 0 to 40 (e.g., from 0 to 35, from 0 to 30, from 0 to 25, from 0 to 20, from 0 to 15, from 0 to 10, from 0 to 5, from 1 to 40, from 1 to 35, from 1 to 30, from 1 to 25, from 1 to 20, from 1 to 15, from 1 to 10, from 1 to 5, from 5 to 40, from 5 to 35, from 5 to 30, from 5 to 25, from 5 to 20, from 5 to 15, from 5 to 10, from 10 to 40, from 10 to 35, from 10 to 30, from 10 to 25, from 10 to 20, from 10 to 15, from 15 to 40, from 15 to 35, from 15 to 30, from 15 to 25, from 15 to 20, from 20 to 40, from 20 to 35, from 20 to 30, from 20 to 25, from 25 to 40, from 25 to 35, from 25 to 30, from 30 to 40, from 30 to 35, from 30 to 40, or from 35 to 40).

In some embodiments, z can be 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40.

In some embodiments, z can be at least 0.1 (e.g., at least 1, at least 5, at least 10, at least 15, at least 20, at least 25, at least 30, or at least 35). In some embodiments, z can be 40 or less (e.g., 35 or less, 30 or less, 25 or less, 20 or less, 15 or less, 10 or less, 5 or less, or 1 or less).

The z can be an integer ranging from any of the minimum values described above to any of the maximum values described above. For example, in some embodiments, z can be an integer from 0 to 40 (e.g., from 0 to 35, from 0 to 30, from 0 to 25, from 0 to 20, from 0 to 15, from 0 to 10, from 0 to 5, from 1 to 40, from 1 to 35, from 1 to 30, from 1 to 25, from 1 to 20, from 1 to 15, from 1 to 10, from 1 to 5, from 5 to 40, from 5 to 35, from 5 to 30, from 5 to 25, from 5 to 20, from 5 to 15, from 5 to 10, from 10 to 40, from 10 to 35, from 10 to 30, from 10 to 25, from 10 to 20, from 10 to 15, from 15 to 40, from 15 to 35, from 15 to 30, from 15 to 25, from 15 to 20, from 20 to 40, from 20 to 35, from 20 to 30, from 20 to 25, from 25 to 40, from 25 to 35, from 25 to 30, from 30 to 40, from 30 to 35, from 30 to 40, or from 35 to 40).

In some embodiments, z is 0. In some embodiments, y is from 3 to 5. In some embodiments, y is from 8 to 12. In some embodiments, y is 4. In some embodiments, y is 10. In some embodiments, y is 4 and z is 0. In some embodiments, y is 10 and z is 0.

In some embodiments, the surface-active gas capture agent can include a compound defined by Formula II or Formula III

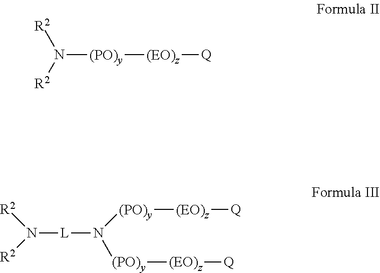

wherein, individually for each occurrence,
   PO represents —CH₂—CH(methyl)-O—;
   EO represents —CH₂—CH₂—O—;
   R² represents, hydrogen, a C₁-C₈ alkyl group, a C₂-C₈ alkenyl group, a C₂-C₈ alkynyl group, an aryl group, an alkylaryl group, or oxyalkylene group POyEOz-Q;
   Q is hydrogen;
   y is an integer from 1 to 60; and
   z is an integer from 0 to 40.

In some embodiments, the surface-active gas capture agent can include a compound defined by Formula II

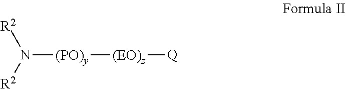

wherein, individually for each occurrence,
   PO represents —CH₂—CH(methyl)-O—;
   EO represents —CH₂—CH₂—O—;
   R² represents, hydrogen, a C₁-C₈alkyl group, a C₂-C₈ alkenyl group, a C₂-C₈ alkynyl group, an aryl group, an alkylaryl group, or oxyalkylene group POyEOz-Q;
   Q is hydrogen;
   y is an integer from 1 to 60; and
   z is an integer from 0 to 40.

In some embodiments, the surface active gas capture agent can include a compound defined by Formula III

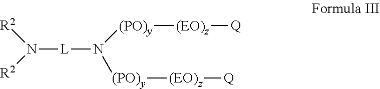

wherein, individually for each occurrence,
   PO represents —CH₂—CH(methyl)-O—;
   EO represents —CH₂—CH₂—O—;
   R² represents, hydrogen, a C₁-C₈alkyl group, a C₂-C₈ alkenyl group, a C₂-C₈ alkynyl group, an aryl group, an alkylaryl group, or oxyalkylene group POyEOz-Q;
   Q is hydrogen;
   y is an integer from 1 to 60; and
   z is an integer from 0 to 40.

In some embodiments, R² can be hydrogen. In some embodiments, R² can be a C₁-C₈ alkyl group. In some embodiments, R² can be a C₂-C₈ alkenyl group. In some embodiments, R² can be a C₂-C₈ alkynyl group. In some embodiments, R² can be an aryl group. In some embodiments, R² can be an alkylaryl group. In some embodiments, R² can be a methyl group.

In some embodiments, L can be a C₁-C₈ alkyl, a C₂-C₈ alkenyl, a C₂-C₈ alkynyl. In some embodiments, L can be a C₁-C₈alkyl. In some embodiment, L can be a C₃ alkyl.

In some embodiments, y can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40.

In some embodiments, y can be at least 1 (e.g., at least 5, at least 10, at least 15, at least 20, at least 25, at least 30, or at least 35). In some embodiments, y can be 40 or less (e.g., 35 or less, 30 or less, 25 or less, 20 or less, 15 or less, 10 or less, or 5 or less).

The y can be an integer ranging from any of the minimum values described above to any of the maximum values described above. For example, in some embodiments, y can be an integer from 1 to 40 (e.g., from 1 to 35, from 1 to 30, from 1 to 25, from 1 to 20, from 1 to 15, from 1 to 10, from 1 to 5, from 5 to 40, from 5 to 35, from 5 to 30, from 5 to 25, from 5 to 20, from 5 to 15, from 5 to 10, from 10 to 40, from 10 to 35, from 10 to 30, from 10 to 25, from 10 to 20, from 10 to 15, from 15 to 40, from 15 to 35, from 15 to 30, from 15 to 25, from 15 to 20, from 20 to 40, from 20 to 35, from 20 to 30, from 20 to 25, from 25 to 40, from 25 to 35, from 25 to 30, from 30 to 40, from 30 to 35, from 30 to 40, or from 35 to 40).

In some embodiments, z can be 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40.

In some embodiments, z can be at least 0.1 (e.g., at least 1, at least 5, at least 10, at least 15, at least 20, at least 25, at least 30, or at least 35). In some embodiments, z can be 40 or less (e.g., 35 or less, 30 or less, 25 or less, 20 or less, 15 or less, 10 or less, 5 or less, or 1 or less).

The z can be an integer ranging from any of the minimum values described above to any of the maximum values described above. For example, in some embodiments, z can be an integer from 0 to 40 (e.g., from 0 to 35, from 0 to 30, from 0 to 25, from 0 to 20, from 0 to 15, from 0 to 10, from 0 to 5, from 1 to 40, from 1 to 35, from 1 to 30, from 1 to 25, from 1 to 20, from 1 to 15, from 1 to 10, from 1 to 5, from 5 to 40, from 5 to 35, from 5 to 30, from 5 to 25, from 5 to 20, from 5 to 15, from 5 to 10, from 10 to 40, from 10 to 35, from 10 to 30, from 10 to 25, from 10 to 20, from 10 to 15, from 15 to 40, from 15 to 35, from 15 to 30, from 15 to 25, from 15 to 20, from 20 to 40, from 20 to 35, from 20 to 30, from 20 to 25, from 25 to 40, from 25 to 35, from 25 to 30, from 30 to 40, from 30 to 35, from 30 to 40, or from 35 to 40).

In some embodiments, z is 0. In some embodiments, y is from 3-15. In some embodiments, y is from 15-35. In some embodiments, y is 4. In some embodiments, y is 6. In some embodiments, y is 8. In some embodiments, y is 10. In some embodiments, y is 12. In some embodiments, y is 30. In some embodiments, y is 4 and z is 0. In some embodiments, y is 6 and z is 0. In some embodiments, y is 8 and z is 0. In some embodiments, y is 10 and z is 0. In some embodiments, y is 12 and z is 0. In some embodiments, y is 30 and z is 0.

In some embodiments, the surface-active gas capture agent can be defined by the structure below:

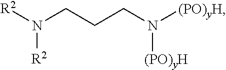

wherein individually for each occurrence,
   PO represents —CH₂—CH(methyl)-O—;
   R² represents, hydrogen, a C₁-C₈ alkyl group, a C₂-C₈ alkenyl group, a C₂-C₈ alkynyl group, an aryl group, an alkylaryl group, or oxyalkylene group POyEOz-Q;
   y is an integer from 1 to 60.

In some embodiments, the surface-active gas capture agent can be selected from:

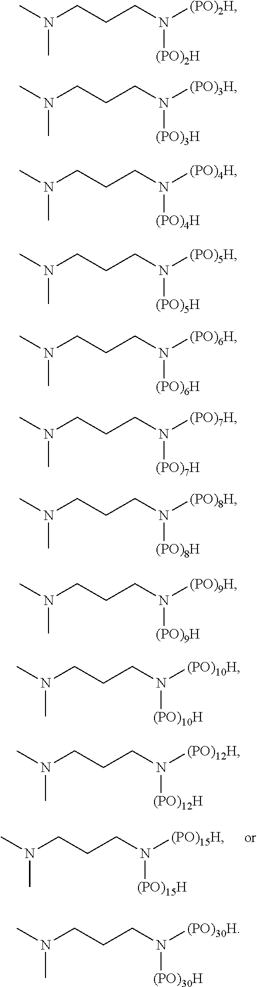

In some embodiments, the surface-active gas capture agent can be present in the capture solution in an amount of at least 0.5% by weight, based on the total weight of the capture solution (e.g., at least 1%, at least 2%, at least 3%, or at least 4%).

In some embodiments, the surface-active gas capture agent can be present in the capture solution in an amount of 5% by weight or less (e.g., 4% or less, 3% or less, 2% or less, or 1% or less).

The surface-active gas capture agent can be present in the capture solution in an amount ranging from any of the minimum values described above to any of the maximum values described above. For examples, in some embodiments, the surface active gas capture agent can be present in the capture solution in an amount of from 0.5% to 5% by weight, based on the total weight of the capture solution (e.g., from 0.5% to 4% by weight, from 0.5% to 3% by weight, from 0.5% to 2% by weight, from 0.5% to 1% by weight, from 1% to 5% by weight, from 1% to 4% by weight, from 1% to 3% by weight, from 1% to 2% by weight, from 2% to 5% by weight, from 2% to 4% by weight, from 2% to 3% by weight, from 3% to 5% by weight, from 3% to 4% by weight, or from 4% to 5% by weight).

### Surfactant

The surfactant can include, but is not limited to, a non-ionic surfactant. The non-ionic surfactant can include a hydrophobic tail comprising from 8 to 32 carbon atoms. In some embodiments, the non-ionic surfactant can include a hydrophobic tail that includes at least 8 carbon atoms (e.g., at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, or at least 31 carbon atoms). In some embodiments, the non-ionic surfactant can include a hydrophobic tail that comprises 32 carbon atoms or less (e.g., 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, or 9 carbon atoms or less).

The non-ionic surfactant can include a hydrophobic tail that comprises a number of carbon atoms ranging from any of the minimum values described above to any of the maximum values described above. For example, in some embodiments, the non-ionic surfactant can include a hydrophobic tail comprising from 8 to 32 carbon atoms (e.g., from 10 to 32, from 15 to 32, from 20 to 32, from 25 to 32, from 8 to 30, from 10 to 30, from 15 to 30, from 20 to 30, from 25 to 30, from 8 to 25, from 10 to 25, from 15 to 25, from 20 to 25, from 8 to 20, from 10 to 20, from 15 to 20, from 8 to 15, from 10 to 15, or from 8 to 10). In some cases, the hydrophobic tail may be a straight chain, branched chain, and/or may comprise cyclic structures. The hydrophobic carbon tail may include single bonds, double bonds, triple bonds, or any combination thereof. In some cases, the hydrophobic tail can comprise an alkyl group, with or without an aromatic ring (e.g., a phenyl ring) attached to it. In some embodiments, the hydrophobic tail can comprise a branched hydrophobic tail derived from Guerbet alcohols.

Example non-ionic surfactants include alkyl aryl alkoxy alcohols, alkyl alkoxy alcohols, or any combination thereof. In embodiments, the non-ionic surfactant may be a mix of surfactants with different length lipophilic tail chain lengths. For example, the non-ionic surfactant may be C8-C11:9PO, which indicates a mixture of non-ionic surfactants that have a lipophilic tail length of 8 carbon to 11 carbon, which is followed by a chain of 9 POs. The hydrophilic moiety is an alkyleneoxy chain (e.g., an ethoxy (EO), butoxy (BO) and/or propoxy (PO) chain with two or more repeating units of EO, BO, and/or PO). In some embodiments, 0-40 repeating units of EO are present. In some embodiments, 0-40 repeating units of PO are present. In some embodiments, 0-10 repeating units of BO are present. For example, the non-ionic surfactant could comprise 7PO:8EO or 10PO. In some embodiments, the non-ionic surfactant may be a mix of surfactants with different length lipophilic tail chain lengths. For example, the non-ionic surfactant may be C8-C11:7PO:8EO, which indicates a mixture of non-ionic surfactants that have a lipophilic tail length of 9 carbon to 11 carbon, which is followed by a chain of 7 Pos and 8 Eos. In some embodiments, the non-ionic surfactant is a Guerbet PO(0-40) and EO(0-40) (Guerbet can be C8-C32); or alkyl PO(0-40) and EO(0-40): where the alkyl group is linear or branched C8-C32. In some embodiments, the non-ionic surfactant is a Guerbet PO(0-40) and EO(1-40) (Guerbet can be C8-C32); or alkyl PO(0-40) and EO(1-40): where the alkyl group is linear or branched C8-C32. In some embodiments, the non-ionic surfactant is a Guerbet PO(1-40) and EO(0-40) (Guerbet can be C8-C32); or alkyl PO(1-40) and EO(0-40): where the alkyl group is linear or branched C8-C32. In some embodiments, the non-ionic surfactant is a Guerbet PO(1-40) and EO(1-40) (Guerbet can be C8-C32); or alkyl PO(1-40) and EO(1-40): where the alkyl group is linear or branched C8-C32. In some embodiments, the non-ionic surfactant is a Guerbet PO(6-8) and EO(7-9) (Guerbet can be C8-C12); or alkyl PO(6-8) and EO(7-9): where the alkyl group is linear or branched C8-C12. In some examples, the non-ionic surfactant can comprise a branched or unbranched C8-C32:PO(0-40):EO(0-40) (e.g., a branched or unbranched C8-C32:PO(1-40):EO(0-40), a branched or unbranched C8-C32:PO(0-40):EO(1-40), a branched or unbranched C8-C32:PO(1-40):EO(1-40), a branched or unbranched C8-C32:PO(6-8):EO(7-9), a branched or unbranched C8-C32:PO(6-8):EO(7-9), a branched or unbranched C8-C12:PO(30-40):EO(25-35), a branched or unbranched C8-C12:PO(30-40):EO(25-35), a branched or unbranched C8-30:EO(8-30), or any combination thereof).

In some embodiments, the surfactant can include an alcohol alkoxylate. In some embodiments, the alcohol alkoxylate can include at least one propoxy segment.

In some embodiments, the surfactant can be defined by Formula I

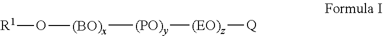

wherein
   BO represents —CH₂—CH(ethyl)-O— and/or —CH₂CH(—)CH(O—)CH₂—;
   PO represents —CH₂—CH(methyl)-O—;
   EO represents —CH₂—CH₂—O—;
   R¹ represents a C₈-C₃₂ alkyl group, a C₈-C₃₂ alkenyl group, a C₈-C₃₂ alkynyl group, an aryl group, or an alkylaryl group;
   Q is hydrogen;
   x is an integer from 0 to 10;
   y is an integer from 0 to 40; and
   z is an integer from 0 to 40,
with the proviso that at least one of x, y, and z is greater than 0.

In some embodiments, R¹ can be a C₈-C₃₂ alkyl group. In some embodiments, R¹ can be a C₈-C₃₂ alkenyl group. In some embodiments, R¹ can be a C₈-C₃₂ alkynyl group. In some embodiments, R¹ can be an aryl group. In some embodiments, R¹ can be an alkylaryl group. In some embodiments, R¹ can be a C₈ alkyl group.

In some embodiments, x can be 0, 1, 2, 3, 4, 5, 6, 7, 8, 9, or 10.

In some embodiments, x can be at least 0.1 (e.g., at least 0.5, at least 1, at least 2.5, at least 5, or at least 7.5). In some embodiments, x can be 10 or less (e.g., 7.5 or less, 5 or less, 2.5 or less, 1 or less, or 0.5 or less).

The x can be an integer ranging from any of the minimum values described above to any of the maximum values described above. For example, in some embodiments, x can be an integer from 0 to 10 (e.g., from 0 to 7.5, from 0 to 5, from 0 to 2.5, from 1 to 10, from 1 to 7.5, from 1 to 5, from 1 to 2.5, from 5 to 10, from 5 to 7.5, or from 7.5 to 10).

In some embodiments, y can be 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40.

In some embodiments, y can be at least 0.1 (e.g., at least 1, at least 5, at least 10, at least 15, at least 20, at least 25, at least 30, or at least 35). In some embodiments, y can be 40 or less (e.g., 35 or less, 30 or less, 25 or less, 20 or less, 15 or less, 10 or less, 5 or less, or 1 or less).

The y can be an integer ranging from any of the minimum values described above to any of the maximum values described above. For example, in some embodiments, y can be an integer from 0 to 40 (e.g., from 0 to 35, from 0 to 30, from 0 to 25, from 0 to 20, from 0 to 15, from 0 to 10, from 0 to 5, from 1 to 40, from 1 to 35, from 1 to 30, from 1 to 25, from 1 to 20, from 1 to 15, from 1 to 10, from 1 to 5, from 5 to 40, from 5 to 35, from 5 to 30, from 5 to 25, from 5 to 20, from 5 to 15, from 5 to 10, from 10 to 40, from 10 to 35, from 10 to 30, from 10 to 25, from 10 to 20, from 10 to 15, from 15 to 40, from 15 to 35, from 15 to 30, from 15 to 25, from 15 to 20, from 20 to 40, from 20 to 35, from 20 to 30, from 20 to 25, from 25 to 40, from 25 to 35, from 25 to 30, from 30 to 40, from 30 to 35, from 30 to 40, or from 35 to 40).

In some embodiments, z can be 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40.

In some embodiments, z can be at least 0.1 (e.g., at least 1, at least 5, at least 10, at least 15, at least 20, at least 25, at least 30, or at least 35). In some embodiments, z can be 40 or less (e.g., 35 or less, 30 or less, 25 or less, 20 or less, 15 or less, 10 or less, 5 or less, or 1 or less).

The z can be an integer ranging from any of the minimum values described above to any of the maximum values described above. For example, in some embodiments, z can be an integer from 0 to 40 (e.g., from 0 to 35, from 0 to 30, from 0 to 25, from 0 to 20, from 0 to 15, from 0 to 10, from 0 to 5, from 1 to 40, from 1 to 35, from 1 to 30, from 1 to 25, from 1 to 20, from 1 to 15, from 1 to 10, from 1 to 5, from 5 to 40, from 5 to 35, from 5 to 30, from 5 to 25, from 5 to 20, from 5 to 15, from 5 to 10, from 10 to 40, from 10 to 35, from 10 to 30, from 10 to 25, from 10 to 20, from 10 to 15, from 15 to 40, from 15 to 35, from 15 to 30, from 15 to 25, from 15 to 20, from 20 to 40, from 20 to 35, from 20 to 30, from 20 to 25, from 25 to 40, from 25 to 35, from 25 to 30, from 30 to 40, from 30 to 35, from 30 to 40, or from 35 to 40).

In some embodiments, at least x is greater than 0. In some embodiments, at least y is greater than 0. In some embodiments, at least z is greater than 0. In some embodiments, x is 0. In some embodiments, y is from 5 to 10. In some embodiments, z is from 5 to 10. In some embodiments, y is from 6 to 8. In some embodiments, z is from 7 to 9. In some embodiments, x is 0, y is from 5 to 10, and z is from 5 to 10. In some embodiments, x is 0, y is from 6 to 8, and z is from 7 to 9. In some embodiments, x is 0, y is 7 and z is 8.

In some embodiments, the surfactant can be defined by Formula IA

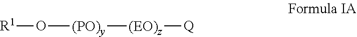

wherein
   BO represents —CH₂—CH(ethyl)-O— and/or —CH₂CH(—)CH(O—)CH₂—;
   PO represents —CH₂—CH(methyl)-O—;
   EO represents —CH₂—CH₂—O—;
   R¹ represents a C₈-C₃₂ alkyl group, a C₈-C₃₂ alkenyl group, a C₈-C₃₂ alkynyl group, an aryl group, or an alkylaryl group;
   Q is hydrogen;
   y is an integer from 1 to 40; and
   z is an integer from 1 to 40.

In some embodiments, R¹ can be a C₈-C₃₂ alkyl group. In some embodiments, R¹ can be a C₈-C₃₂ alkenyl group. In some embodiments, R¹ can be a C₈-C₃₂ alkynyl group. In some embodiments, R¹ can be an aryl group. In some embodiments, R¹ can be an alkylaryl group. In some embodiments, R¹ can be a C₈ alkyl group.

In some embodiments, the surfactant of Formula I can be defined by the structure below:

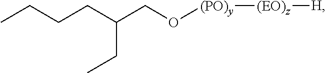

wherein
   PO represents —CH₂—CH(methyl)-O—;
   EO represents —CH₂—CH₂—O—;
   y is an integer from 1 to 40; and
   z is an integer from 1 to 40.

In some embodiments, y can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40.

In some embodiments, y can be at least 1 (e.g., at least 5, at least 10, at least 15, at least 20, at least 25, at least 30, or at least 35). In some embodiments, y can be 40 or less (e.g., 35 or less, 30 or less, 25 or less, 20 or less, 15 or less, 10 or less, or 5 or less).

The y can be an integer ranging from any of the minimum values described above to any of the maximum values described above. For example, in some embodiments, y can be an integer from 1 to 40 (e.g., from 1 to 35, from 1 to 30, from 1 to 25, from 1 to 20, from 1 to 15, from 1 to 10, from 1 to 5, from 5 to 40, from 5 to 35, from 5 to 30, from 5 to 25, from 5 to 20, from 5 to 15, from 5 to 10, from 10 to 40, from 10 to 35, from 10 to 30, from 10 to 25, from 10 to 20, from 10 to 15, from 15 to 40, from 15 to 35, from 15 to 30, from 15 to 25, from 15 to 20, from 20 to 40, from 20 to 35, from 20 to 30, from 20 to 25, from 25 to 40, from 25 to 35, from 25 to 30, from 30 to 40, from 30 to 35, from 30 to 40, or from 35 to 40).

In some embodiments, z can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40.

In some embodiments, z can be at least 1 (e.g., at least 5, at least 10, at least 15, at least 20, at least 25, at least 30, or at least 35). In some embodiments, z can be 40 or less (e.g., 35 or less, 30 or less, 25 or less, 20 or less, 15 or less, 10 or less, or 5 or less).

The z can be an integer ranging from any of the minimum values described above to any of the maximum values described above. For example, in some embodiments, z can be an integer from 1 to 40 (e.g., from 1 to 35, from 1 to 30, from 1 to 25, from 1 to 20, from 1 to 15, from 1 to 10, from 1 to 5, from 5 to 40, from 5 to 35, from 5 to 30, from 5 to 25, from 5 to 20, from 5 to 15, from 5 to 10, from 10 to 40, from 10 to 35, from 10 to 30, from 10 to 25, from 10 to 20, from 10 to 15, from 15 to 40, from 15 to 35, from 15 to 30, from 15 to 25, from 15 to 20, from 20 to 40, from 20 to 35, from 20 to 30, from 20 to 25, from 25 to 40, from 25 to 35, from 25 to 30, from 30 to 40, from 30 to 35, from 30 to 40, or from 35 to 40).

In some embodiments, y is from 5 to 10. In some embodiments, z is from 5 to 10. In some embodiments, y is from 6 to 8. In some embodiments, z is from 7 to 9. In some embodiments, y is from 5 to 10, and z is from 5 to 10. In some embodiments, y is from 6 to 8, and z is from 7 to 9. In some embodiments, y is 7 and z is 8.

In some embodiments, the surfactant exhibits an HLB value of at least 6 (e.g., at least 5, at least 7, at least 8, at least 9, at least 10, at least 11, at least 12, at least 13, or at least 14).

In some embodiments, the surfactant exhibits an HLB value of 15 or less (e.g., 15 or less, 14 or less, 13 or less, 12 or less, 11 or less, 10 or less, 9 or less, 8 or less, or 7 or less).

In some embodiments, the surfactant exhibits an HLB value of from 6 to 15 (e.g., from 6 to 8, from 6 to 10, from 6 to 12, from 6 to 14 from 8 to 10, from 8 to 12, from 8 to 15, from 10 to 12, from 10 to 15, or from 12 to 15).

In some embodiments, the surfactant can be present in the capture solution in an amount of at least 0.5% by weight, based on the total weight of the capture solution (e.g., at least 1%, at least 2%, at least 3%, or at least 4%).

In some embodiments, the surfactant can be present in the capture solution in an amount of 5% by weight or less (e.g., 4% or less, 3% or less, 2% or less, or 1% or less).

The surfactant can be present in the capture solution in an amount ranging from any of the minimum values described above to any of the maximum values described above. For examples, in some embodiments, the surfactant can be present in the capture solution in an amount of from 0.5% to 5% by weight, based on the total weight of the capture solution (e.g., from 0.5% to 4% by weight, from 0.5% to 3% by weight, from 0.5% to 2% by weight, from 0.5% to 1% by weight, from 1% to 5% by weight, from 1% to 4% by weight, from 1% to 3% by weight, from 1% to 2% by weight, from 2% to 5% by weight, from 2% to 4% by weight, from 2% to 3% by weight, from 3% to 5% by weight, from 3% to 4% by weight, or from 4% to 5% by weight).

### Methods

The capture solutions described herein can be used in methods and systems for carbon capture, such as those described in U.S. Pat. Nos. 7,938,887 and 9,956,505, each of which is hereby incorporated by reference in its entirety.

Described herein are methods for capturing an acidic gas from a gas stream. In some embodiments, the method can include: contacting the gas stream with a capture solution comprising a gas capture agent and a surfactant.

In some embodiments, the method can include: contacting the gas stream with a capture solution comprising a surface active gas capture agent. In some embodiments, the capture solution can further include a surfactant.

In some embodiments, the gas stream can include one or more gases chosen from a flue gas, a natural gas, a hydrogen gas, and a synthesis gas. In some embodiments, the acidic gas can be chosen from one or more of CO₂, H₂S, COS, CS₂, and mercaptans. In some embodiments, the acidic gas can include CO₂.

In some embodiments, the method can further include subsequently routing the capture solution through a stripper.

Reference will now be made in detail to specific aspects of the disclosed materials, compounds, compositions, articles, and methods, examples of which are illustrated in the accompanying Examples and Figures.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. More specifically, it will be apparent that certain agents which are both chemically related may be substituted for the agents described herein while the same or similar results would be achieved. All such similar substitutes and modifications apparent to those skilled in the art are deemed to be within the spirit, scope and concept of the disclosure as defined by the appended claims.

By way of non-limiting illustration, examples of certain embodiments of the present disclosure are given below.

### EXAMPLES

### Example 1: CO₂ Capture as Bicarbonate Using DMAPA with Incorporation of Surface Activity

Described herein is the CO₂ capture and in-situ conversion into bicarbonate as a carbon-bearing product using an amine with built-in surface activity. The surface-active amine was 3-(dimethylamino) propylamine (DMAPA) modified with propylene oxide (PO) groups (DMAPA-xPO, x=4, 6, 8, 12). Analysis of the CO₂ capture capacity data with ¹³C Nuclear Magnetic Resonance (NMR) spectroscopy determined the bicarbonate concentrations and the generation mechanism during the CO₂ capture influenced by the PO groups, establishing a relationship between CO₂ solubility, pH of the solution, and steric effect. Results demonstrated the effectiveness of the built-in surface activity with an optimal PO level (DMAPA-6PO). DMAPA-6PO enhanced the bicarbonate generation by 54%, in comparison to DMAPA, under ambient conditions.

The current energy demands depend mainly on fossil fuels, such as coal, oil, and natural gas. The chemical energy extracted from them by combustion is broadly used for transportation, electricity generation, industrial processes, and heating. Their emitted pollutants are causing adverse effects on the environment and human health. In particular, carbon dioxide (CO₂) is one of the greenhouse gases and 92.4% of CO₂ emissions were caused by fossil fuel combustion in the United States in 2019 [1,2].

Different routes can mitigate CO₂ emissions, such as reducing energy use, improving energy efficiency, shifting to low-carbon or even non-carbon energy processes, and implementing carbon capture and utilization (CCU) systems [2]. CCU into fuels and chemicals are considered a suitable option to stabilize atmospheric greenhouse gas concentrations in the energy transition [3,4]. Using emitted CO₂ gas as feedstock to manufacture value-added products provides not only environmental benefits, but also opportunities for chemical industries to develop new production methods.

Amine-based post-combustion capture (PCC) is a well-proven and commercially used technology for CO₂ capture in the petroleum sector, coal-fired power, and cement industries, with a CO₂ recovery rate up to 800 tons/day [5-7]. This process typically uses a single or a blend of reactive aqueous amine solutions to react chemically with CO₂ gas in an acid-base reaction. Then, the CO₂ gas is subsequently stripped from the amine solution at high temperatures (120-180° C.), regenerating the solvent [5]. However, the regeneration step is considered the main drawback of this technology because of its high regeneration cost, approximately 70% of the total operating cost [8].

Different approaches have been made to reducing energy consumption in PCC. The most common strategy is the development of less energy-intensive capture solvents, which are mixtures of different amines or ionic liquids (IL) [9-15]. However, this approach still requires heating for CO₂ desorption and amine regeneration. The necessity of heating can be avoided when CO₂ is captured to yield a non-gaseous carbon species to be directly used as a feedstock, such as bicarbonate (HCO₃⁻).

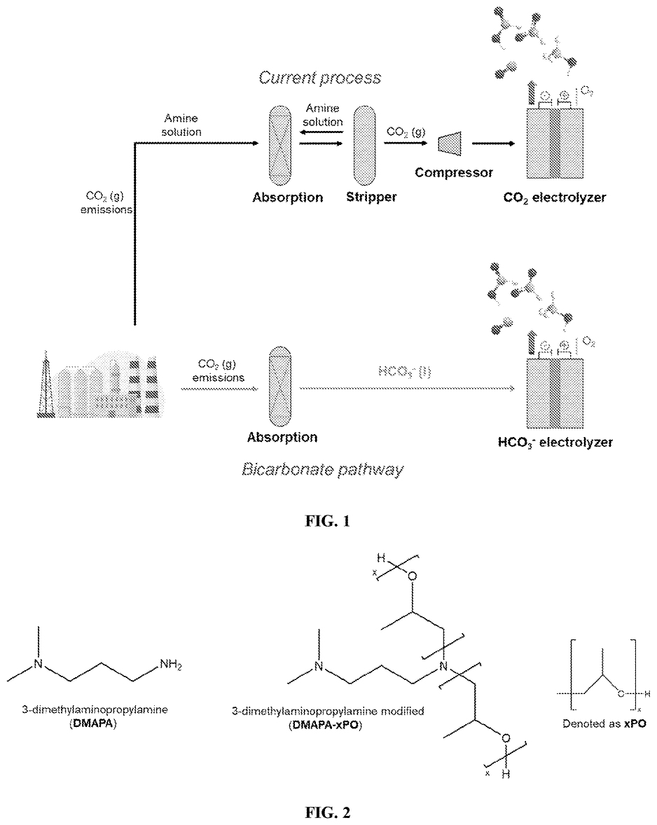

Capturing CO₂ in the form of bicarbonate can be an effective, practical, and stable way not only to store and deliver a CO₂-bearing product into the utilization unit, but also to overcome the CO₂ mass transfer limitation in aqueous carbon capture technologies because of the higher carbon concentration in saturated solution (3.3 M for saturated KHCO₃ compared with 0.033 M for saturated CO₂) [16]. For example, the energy requirement for capturing CO₂ into potassium bicarbonate, 1.0 MJ/100 mol CO₂, is lower than that for capturing CO₂ into potassium carbonate in the direct air capture (DAC) process, 1.3 MJ/100 mol CO_{2 [17}]. Therefore, the bicarbonate pathway as an alternative CO₂ capturing route has considerable potential for post-combustion technology applications, and can be integrated into a conversion step such as electrochemical conversion to produce various chemicals and fuels, as shown in FIG. 1.

Tertiary amines react with CO₂ in a 1:1 mol ratio and produce bicarbonate with slow capture kinetics [18]. Although primary amines have demonstrated faster CO₂ capture kinetics than tertiary amines, they mainly produce carbamate (R—NHCOO⁻) from this reaction [19,20]. Thus, a combined effect between a primary and tertiary amine is expected to improve the bicarbonate generation rate. For example, 3-(dimethylamino) propylamine or DMAPA, which is a diamine with one tertiary and one primary amino group, is a potential amine for this purpose. Even though DMAPA has been used as an experimental and simulation CO₂ capture solution model with analytical bicarbonate detection in the literature [21-23], it has not been studied for the bicarbonate generation as a CO₂ capture pathway or for the optimal experimental conditions for its production.

Additionally, surfactants have been studied to potentially enhance the CO₂ capture performance of different amine solutions since they lower their surface tension, increase the surface where CO₂ and amine react, and facilitate the CO₂ mass transfer into the aqueous solution [24-26]. In particular, low-concentration surfactants with short hydrophilic chains of less than ten carbons, such as ethylene oxide groups (EO), improved the CO₂ capture of monoethanolamine solutions (MEA) [27]. However, the effect of these surfactants was only studied when they were added to amine solutions without considering the bicarbonate generation [28,29]. No report has been published on incorporating surfactant characteristics into an amine for bicarbonate generation. Such amine species with built-in surface activity is referred to as surface-active amine in this research.

The envisioned applications of CO₂ capture as bicarbonate include an integrated CO₂ capture/conversion process via bicarbonate electrolysis as part of the potential pathways of carbon capture, utilization, and storage (CCUS). Since the bicarbonate product is not bonded to the surface-active amine (as carbamate), membrane technologies can cost-effectively separate bicarbonate because of their modular configuration, compactness, operational flexibility, and simplicity, as an alternative to the conventional thermal regeneration [30,31]. For instance, researchers have studied the direct electrolysis of the captured CO₂-amine solution, including MEA and AMP solutions, [32-34] and some surfactants in the media, such as CTAB [35]. Their studies indicated that CO₂ reduction can be negatively affected when such complex components in the electrolyte prevent CO₂ from reaching the electrocatalysts' active sites. Thus, the separation process can be an important step for the selective formation of the desired product in the bicarbonate pathway.

This paper reports an investigation of the CO₂ capture into bicarbonate using a surface-active amine as capturing solution. The surface-active amine was generated by attaching PO groups to DMAPA's primary amino group at different levels (DMAPA-xPO, x=4, 6, 8, 12). The CO₂ capture capacity and the bicarbonate generation were analyzed by ¹³C NMR spectroscopy. Results showed that surface-active amine with an optimal PO level (DMAPA-6PO) enhanced the bicarbonate concentration by approximately 54%, in comparison to DMAPA with no PO attached, because of enhanced CO₂ solubilization in the aqueous media.

### Chemicals

DMAPA and DMAPA-based surface-active amines (DMAPA-xPO) were provided by Harcros Chemicals. The carbon dioxide (CO₂) gas of an industrial grade (99.5%) was obtained from Linde Gas & Equipment Inc. Hydrochloric acid (HCl) 3N and methyl orange indicator powder were purchased from Aqua Solutions and Thermo Scientific, respectively. All chemicals were used without further purification. FIG. 2 shows the chemical structure of the previously mentioned amines.

### CO₂ Capture Experiments

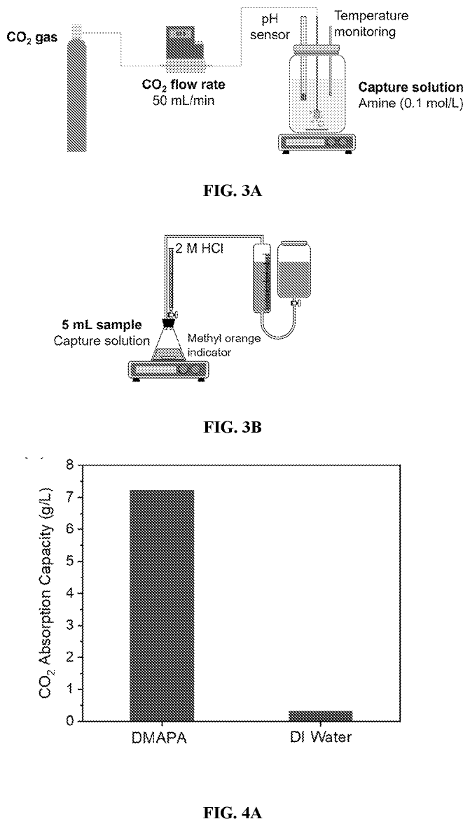

The overall CO₂ capture performance was evaluated by (1) the CO₂ absorption capacity and (2) the CO₂ loading of the samples with the experimental setup shown in FIG. 3A-3B. For the CO₂ absorption capacity (FIG. 3A), a mass flow controller (FMA5508A-ST-CO₂ model by OMEGA Engineering Inc.) continuously supplied CO₂ gas at 50 mL/min into the capture solution in a glass reactor at room temperature. The solution was 600 mL of DMAPA or DMAPA-xPO (x=4, 6, 8, and 12) with a concentration of 0.116 mol/L for all experiments. All solutions were prepared with deionized (DI) water (18.2 M (2·cm resistivity). A stainless-steel sparger with a mean pore size of 2-10 μm was used as a nozzle tip for the CO₂ bubbling line. The temperature and pH were monitored during the tests using the Fisher Scientific Accumet AE150 pH meter. The absorption experiments were finished when the pH of the capture solution became constant. The amount of CO₂ absorbed by the capture solution was determined by measuring the mass of the solution before and after each test by using the Mettler Toledo ML104T analytical balance; hence, no samples were taken for measuring the CO₂ adsorption capacity.

In a second run of each CO₂ absorption experiment under the same conditions, a 5 mL sample from the capture solution was taken every 10 minutes and placed into an Erlenmeyer flask for the CO₂ loading determination by titration using 2 M HCl solution and methyl orange as the indicator. FIG. 3B gives a schematic of the setup. During HCl addition, CO₂ gas was released upwards the glass tubing displacing the non-reactive solution mixture level (H₂SO₄, NaHCO₃, and NaCl) [27]. The CO₂ loading was calculated by using the following equation [36]:

$${α}_{{CO}_{2}} = \frac{{mol}_{{CO}_{2}}}{{mol}_{a bsorbent}} = \frac{\frac{P ( {V}_{g a s} - {V}_{H C l} )}{R T}}{{C}_{1} {V}_{1}} \qquad ( Equation 1 )$$

where α_{CO}_{₂} is the CO₂ loading defined as mol of CO₂ captured per mole of absorbent, R denotes the gas constant (8.314 L kPa/mol K), P (kPa) and T (K) are the atmospheric pressure and temperature, respectively. C₁ (mol/L) and V₁ (mL) are the concentration and volume of the sample from the capture solution tested. The V_{gas}-V_{HCl} term represents the volume of the released CO₂ gas (mL) less the HCl volume used in the titration from the measured volume of the displaced liquid. Additionally, the CO₂ loading rate was calculated from the slope of the linear portion in the CO₂ loading history.

### NMR Analysis

¹³C NMR spectroscopy was used to determine the carbon species generated from the CO₂ capture process, in particular, bicarbonate and carbamate. Therefore, 0.5 mL of the capture solution was collected and measured every 10 min during the absorption experiments. The samples were prepared with 100 μL of deuterium oxide (Thermo Scientific, for NMR 99.8 atom % D) to lock the system [37,38]. All analyses were carried out with a relaxation delay time of 2 s and a number of scans of 1024 using the Bruker Avance III 500 instrument. A calibration curve was used for the bicarbonate quantification. Thus, bicarbonate solutions of 0.05-3 mol/L concentration were prepared using potassium bicarbonate (Honeywell, ACS reagent ≥99.7%). FIG. 20A-20B of Supporting Information shows the obtained calibration curve. Alternatively, the quantification of carbamate was also estimated based on the following equation [38]:

$${m}_{a} = {m}_{b} \frac{{N}_{b}}{{N}_{a}} \frac{{A}_{a}}{{A}_{b}} \frac{{M}_{a}}{{M}_{b}} \qquad ( Equation 2 )$$

where N is the number of carbons related to the signal, A is the area under the NMR signal, M is the molecular weight, mb is the mass of the reference material, and mₐ is the mass of the analyte. As the reference, 0.02 g of tetramethylammonium chloride (Acros Organics, 98+%) was added during the sample preparation. The bicarbonate amount was also estimated by Equation 2 and compared with NMR results, as listed in Table S1.

TABLE S1
Calculated bicarbonate concentration
comparison from ¹³C NMR results.

| | Calculation from | Calculation from |
|---|---|---|
| Reference concentration | calibration curve^{a} | Equation 2^{b} |
| (mol/L) | (mol/L) | (mol/L) |
| 0.05 | 0.0472 | 0.0513 |
| 0.10 | 0.1015 | 0.0989 |
| 0.15 | 0.1438 | 0.1456 |
| 0.20 | 0.1991 | 0.1848 |
| 0.25 | 0.2497 | 0.2315 |
| 0.30 | 0.3003 | 0.2943 |

^{a}Calculated error: 5.5%;
^{b}calculated error: 7.6%.

The bicarbonate concentration was calculated using Equation 2 with the bicarbonate peak area from ¹³C NMR spectrum, considering 0.5 mL of sample for each analysis. Below is an example of calculating one concentration.

### Reference Concentration: 0.05 Mol/L Bicarbonate Solution.

$${m}_{0.05}^{′} = {m}_{ref} \frac{{N}_{r e f}}{{N}_{{HCO}_{3}^{-}}} \frac{{A}_{0.05}^{′}}{{A}_{ref}} \frac{{M}_{{HCO}_{3}^{-}}}{{M}_{ref}} = 0.022 g \times \frac{4}{1} \times \frac{278 4.43 A . U .}{8720 4.87 A . U .} \times \frac{61.01 g / mol}{109.6 g / mol} = 0.0 \; 016 g {HCO}_{3}^{-}$$

$${c}_{0.05}^{′} = \frac{{n}_{0.05}^{′}}{{V}_{sample}} = \frac{{m}_{0.05}^{′} / {M}_{{HCO}_{3}^{-}}}{{V}_{sample}} = \frac{0.0 \; 016 g / 61.01 g / mol}{0.0 \; 005 L} = 0.0 \; 513 mol / L$$

### Surface Tension Measurements

Surface tensions were measured for amine solutions at room temperature by the CNC-DuNouy Interfacial Tensiometer (Cat. No. 70545) from CSC Scientific Company, Inc. The measurement range was 0-90 dynes/cm. A platinum-iridium ring of 6 cm circumference was used for the evaluations. Before each analysis, the ring was cleaned with soap, rinsed with isopropanol, and dried by air.

### Results

### CO₂ Capture Performance of DMAPA and DMAPA-xPO

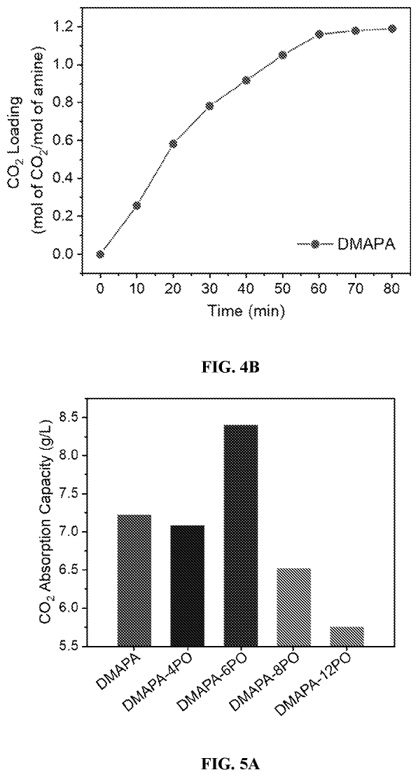

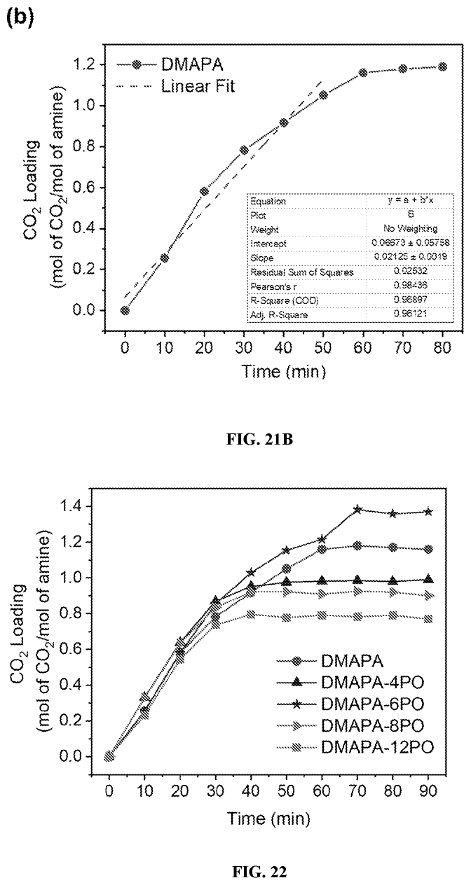

Firstly, the overall CO₂ capture performance of DMAPA without modification was evaluated. FIG. 4A shows the CO₂ adsorption capacity. The mass of CO₂ absorbed by 0.116 mol/L DMAPA solution was 7.22 g/L, which was much greater than that by DI water, 0.33 g/L. The two amino groups present in DMAPA reacted with CO₂ through the zwitterion and the base-catalyzed hydration reactions [39,40], increasing the CO₂ solubility in the media, and therefore, the CO₂ absorption capacity [29]. During the absorption process, the pH of the solution decreased as a consequence of these acid-base reactions, as illustrated in FIG. 21A. The high initial value of 11.97 dropped to 7.20, which remained constant after 80 min of reaction.

The CO₂ loading history with DMAPA is shown in FIG. 4B. After the capture reaction started, the ratio of the CO₂ concentration to the amine concentrations increased to reach a maximum, 1.18 mol of CO₂/mol of amine, from 60-80 min. This loading capacity measured for DMAPA is in concordance with previously reported values, 1.05-1.35 mol of CO₂/mol of amine [23,41,42]. Additionally, the CO₂ loading rate was calculated to be 0.0212 min-1 from the CO₂ loading profile, as observed in FIG. 21B.

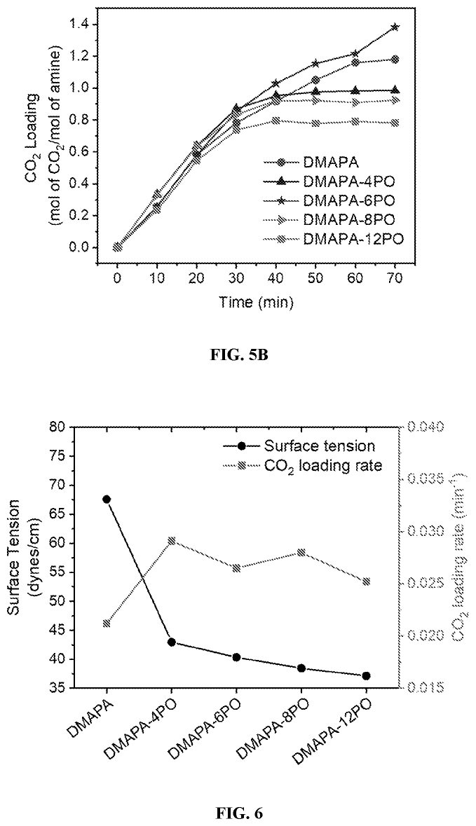

After having completed the performance of DMAPA as a reference sample, the amine with the built-in surface activity at different levels was evaluated as shown in FIG. 5A-5B. Among all the PO levels tested, DMAPA-6PO exhibited the highest CO₂ absorption capacity with 8.40 g/L, which was greater than DMAPA with no PO groups by 16%. PO levels lower (4PO) and higher (8PO and 12PO) than 6PO adversely affected the CO₂ capture capacity, underperforming DMAPA (see FIG. 5A). Thus, the built-in surface activity at the optimum level of 6PO allowed for a greater CO₂ dissolution, resulting in higher absorption capacity.

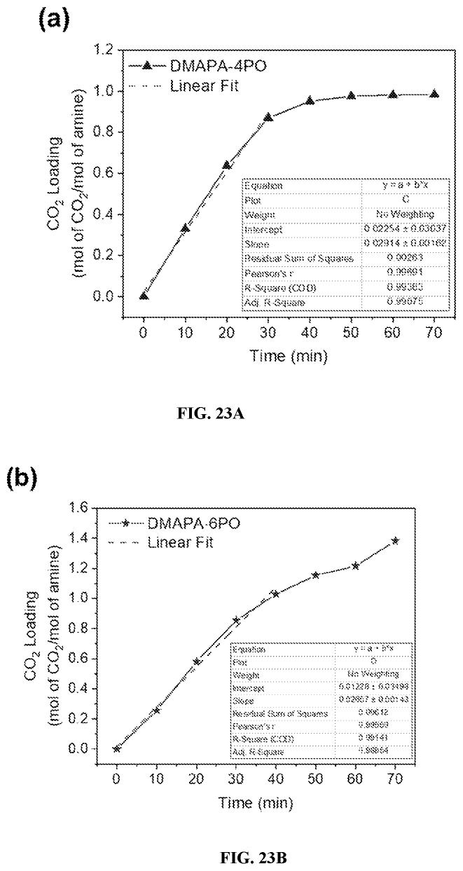

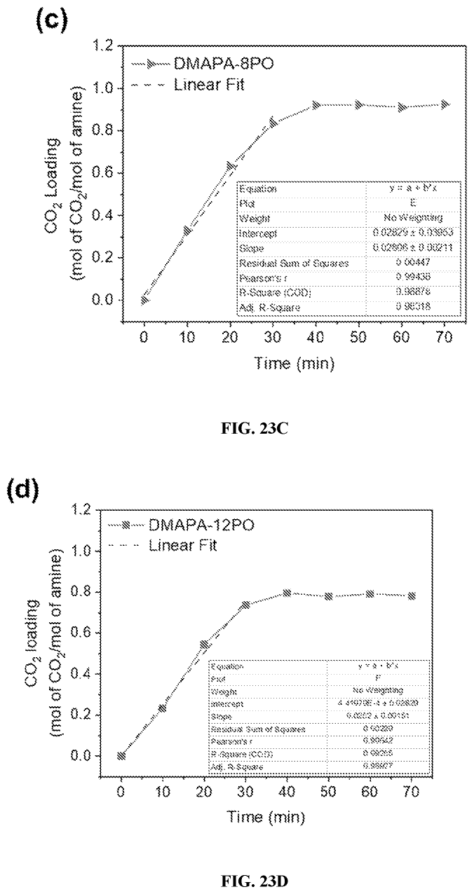

Moreover, the CO₂ loading profiles shown in FIG. 5B corroborated the absorption capacity tests. The optimum 6PO level exhibited the highest loading ratio of 1.38 mol of CO₂/mol of amine at 70 min of reaction. From this point on, the loading capacity was constant over an extended period (FIG. 22). The CO₂ capture kinetics was influenced by the different PO levels, in which an average rate of 0.0265 min⁻¹ was greater than that of DMAPA (see FIG. 23A-23D). All results are summarized in Table 1. Overall, the built-in surface activity enabled DMAPA to increase the CO₂ capture kinetics, while significantly increasing the absorption capacity with the optimal PO level of six.

TABLE 1
Summarized results for the overall CO₂ capture performance
of 0.116 mol/L DMAPA-xPO (x = 4, 6, 8, 12).

| | CO₂ | | CO₂ |
|---|---|---|---|
| | Absorption^{a} | CO₂ Loading^{b} | Loading Rate |
| Sample | (g CO₂/L) | (mol CO₂/mol amine) | (min⁻¹) |
| DMAPA | 7.22 | 1.18 | 0.0212 |
| DMAPA-4PO | 7.08 | 0.98 | 0.0291 |
| DMAPA-6PO | 8.40 | 1.38 | 0.0265 |
| DMAPA-8PO | 6.52 | 0.92 | 0.0280 |
| DMAPA-12PO | 5.75 | 0.78 | 0.0252 |

^{a}STD CO₂ absorption: ±0.03;
^{b}STD CO₂ loading: ±0.02.

The CO₂ dissolution in the capture solution can play an important role in CO₂ capture. Therefore, the effect of PO groups on the surface tension of DMAPA-xPO solution was evaluated as presented in FIG. 6. The surface tension decreased with the PO level, starting at 42.9 dynes/cm for DMAPA-4PO to 37.1 dynes/cm for DMAPA-12PO, which were smaller than 67.6 dynes/cm for DMAPA by 36-45%. The reduction in surface tension likely caused a beneficial effect on the mass transfer rate [43], as shown by the enhanced rates of CO₂ loading capacity in Table 1. FIG. 6 also shows a correlation with the CO₂ loading rate. As the surface tension was reduced by the PO incorporation, the CO₂ loading rate increased up to 0.0291 min⁻¹, which was 37% greater than that of DMAPA. The PO group reduced the surface tension of DMAPA solution, and therefore increased the CO₂ dissolution kinetics.

Although DMAPA-12PO showed the smallest surface tension among those tested, it exhibited the worst performance of CO₂ capture. This observation can be associated with the surfactant properties of incorporated PO groups. A small hydrophobic head, such as propylene oxide (PO), exhibits high CO₂ affinity, resulting in a high CO₂ solubility because of a reduced repulsion in the aqueous media [29,30]. Simultaneously, the increasing steric hindrance because of the longer hydrocarbon chain in the increasing PO level negatively affects the CO₂ capture ability of the amino group [27,44]. Although incorporating PO groups into DMAPA tends to reduce its surface tension to enhance CO₂ dissolution, an optimal balance between CO₂ dissolution and the chemically steric environment is required for the amino group to effectively drive the CO₂ capture reaction. Results in this research showed that this optimal balance was taken by DMAPA-6PO which met the HLB requirement of the CO₂.

Surfactants as additives to an amine solution may promote undesirable foam formation in amine solutions, as reported in the literature [27]. However, the built-in surface activity in DMAPA-xPO samples exhibited negligible foam formation in this research likely because the PO group is a low foaming block [45]. Also, the PO groups at the end of the hydrocarbon chain resulted in low foaming capabilities of nonionic surfactants [45].

### Built-In Vs Added Surface Activity

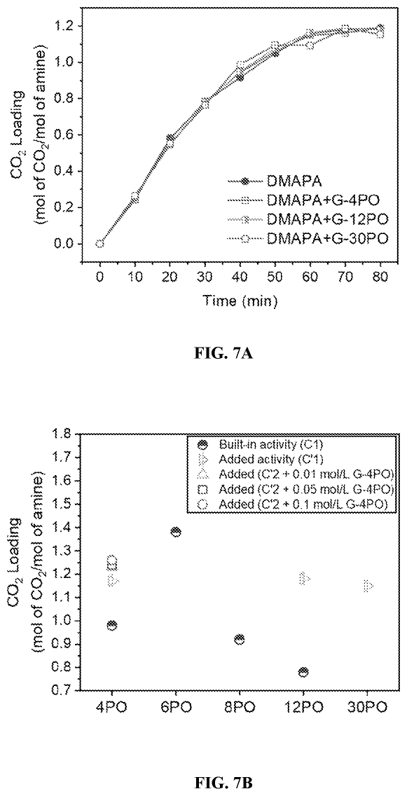

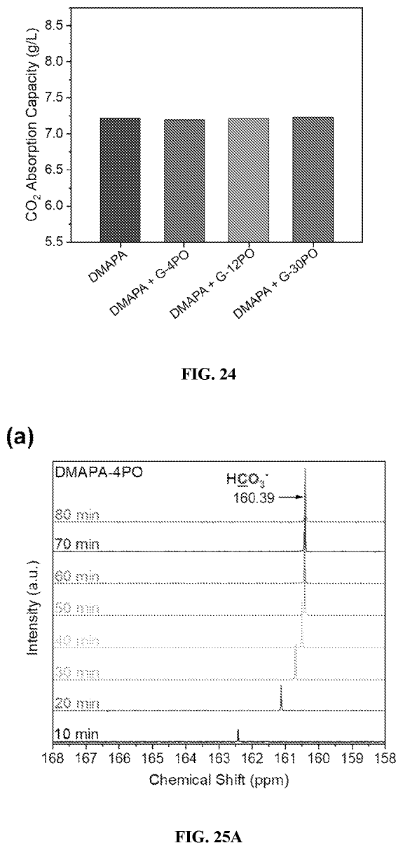

The effectiveness of DMAPA with the built-in surface activity (DMAPA-xPO) was compared to DMAPA with added surface activity (DMAPA+surfactant). For this purpose, glycerol-xPO (x=4, 12, 30) was used as a surfactant additive. The glycerol-xPO samples were prepared and provided by Harcros Chemicals. The results are shown in FIG. 7A-7B. Using a 0.01 mol/L concentration of glycerol-xPO for all different levels and a 0.116 mol/L DMAPA capturing solution did not improve the CO₂ loading capacity. The maximum value was 1.18 mol of CO₂/mol of amine, and they exhibited similar histories as DMAPA (see FIG. 7A). This behavior is related to the constant CO₂ capture capacity shown at all different levels with an average value of 7.21 g/L, as illustrated in FIG. 24.

Additionally, experiments using a higher DMAPA concentration (0.25 mol/L) with a fixed PO level (glycerol-4PO) at concentrations of 0.01, 0.05, and 0.1 mol/L were carried out to evaluate the influence of the added surface activity. As can be seen in FIG. 7B, the results exhibited that no significant CO₂ loading enhancement was achieved by increasing either DMAPA concentration or glycerol-4PO concentration. Through these variations, the maximum CO₂ loading of the mixture was 1.24 mol of CO₂/mol of amine, which was only slightly higher than the 1.22 mol of CO₂/mol amine of 0.25 mol/L DMAPA. All results are listed in Table 2.

This unaffected behavior is in concordance with the literature for different types of surfactants, including nonionic and cationic ones, at different concentrations [27]. Thus, the addition of glycerol-xPO as surfactant to DMAPA solution did not affect its CO₂ capture capacity because of the limited surface activity and tendency to form micelles that tend to limit the mass transfer at the gas-liquid reaction interface [27,28]. It is reasonable to conclude that the built-in surface activity is a promising method to enhance the overall CO₂ capture capacity of an amine-based solution thus demonstrating the efficacy of intra-molecular process over inter molecular-process.

TABLE 2
Summarized results for the added surface activity
experiments using a DMAPA + glycerol-xPO mixture.

| Concentration | Capture | | CO₂ Loading^{a} |
|---|---|---|---|
| (mol/L) | solution | Surfactant | (mol CO₂/mol amine) |
| 0.116 | DMAPA | None | 1.18 |
| | | Glycerol 4-PO | 1.17 |
| | | 0.01 mol/L | |
| | | Glycerol 12-PO | 1.18 |
| | | 0.01 mol/L | |
| | | Glycerol 30-PO | 1.15 |
| | | 0.01 mol/L | |
| 0.25 | DMAPA | None | 1.22 |
| | | Glycerol-4PO | 1.23 |
| | | 0.01 mol/L | |
| | | Glycerol-4PO | 1.24 |
| | | 0.05 mol/L | |
| | | Glycerol-4PO | 1.26 |
| | | 0.10 mol/L | |

^{a}STD CO₂ loading: ±0.02.

### Bicarbonate Production

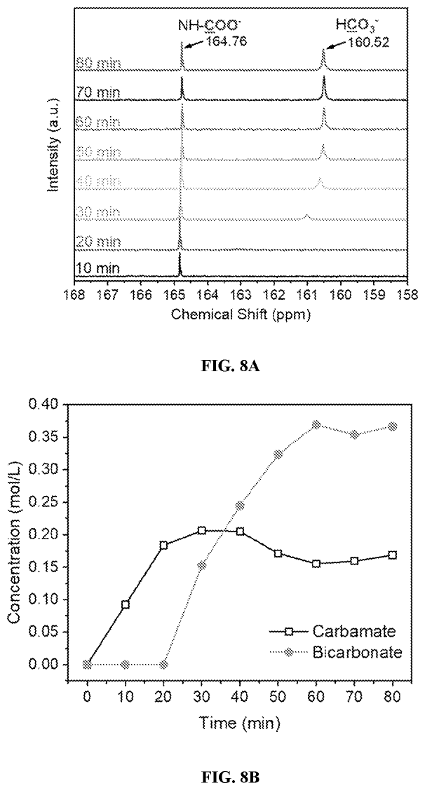

The bicarbonate production analysis and quantification were carried out by ¹³C NMR spectroscopy. For this purpose, the concentration of the amines used in these experiments was increased to 0.25 mol/L. The results for DMAPA are shown in FIG. 8A-8B. From the beginning of the capture process, a signal of carbamate was detected at a chemical shift of 164.76 ppm in the ¹³C NMR spectra as shown in FIG. 8A since DMAPA contains a primary amino group that reacts with CO₂ to form these species [22,46]. In addition, another signal at 160.52 ppm associated with bicarbonate species was observed from 30 min of reaction time because of the reaction product from the tertiary amino group and CO₂, as well as from the hydrolysis of carbamate [23,46]. These results indicated that primary amino group in DMAPA reacted faster than tertiary amino group. The quantification of both species during the reaction is illustrated in FIG. 8B. As it can be seen, the faster carbamate production reached its maximum at 30 min with 0.20 mol/L. From this point on, the concentration decreased until it reached a constant value around 0.16 mol/L, corroborating the hydrolysis process of carbamate species. Additionally, bicarbonate generation was detected from 20 min, and it reached a constant concentration around 0.36 mol/L at 60 min of reaction. Therefore, the bicarbonate generation by DMAPA was retarded for 20 mins by the carbamate generation.

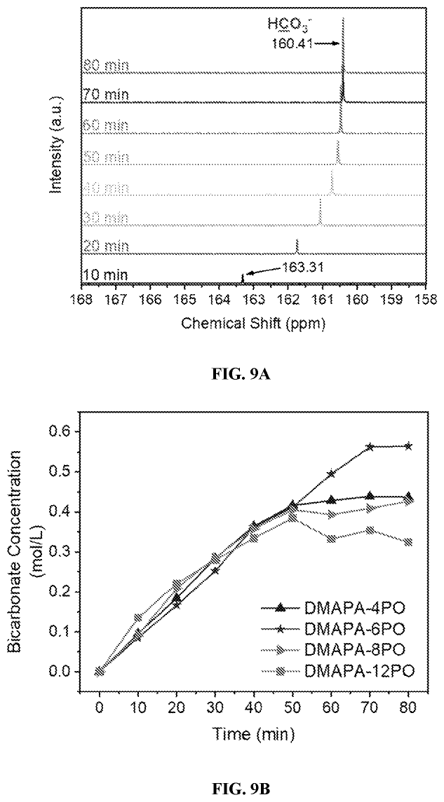

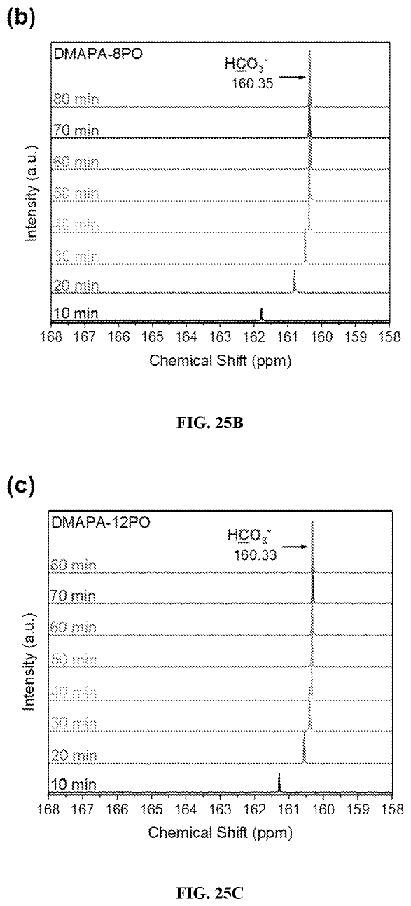

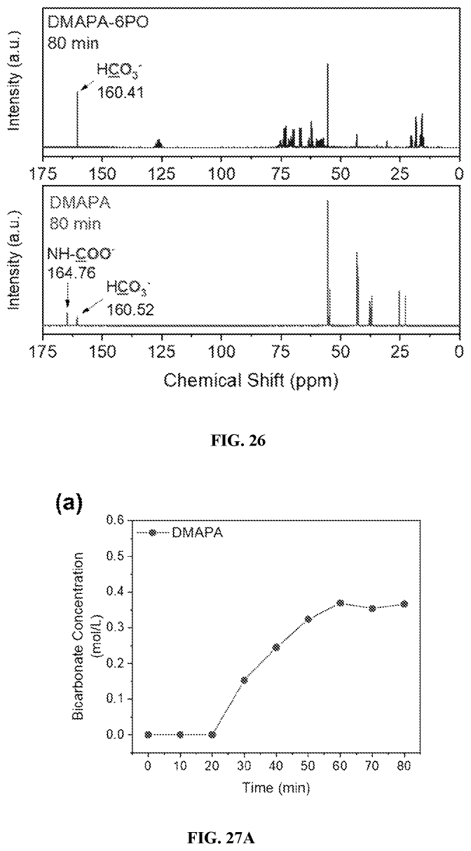

The ¹³C NMR spectra obtained from the DMAPA-6PO are shown in FIG. 9A. A single C═O signal at 163.31 ppm was observed after 10 mins of the reaction. Since the resonances of carbonate and bicarbonate species are expected at 168.5 and 160.5 ppm, respectively, this observed signal can be related to a carbonate and bicarbonate mixture in rapid equilibrium with a higher concentration of carbonate species because of the initial high pH value of the reaction (pH=12.27) [46-48]. As the reaction continued and more CO₂ was introduced into the solution, the intensity of this signal increased and shifted to 160.41 ppm accompanied by a decrease in pH to 7.12, as evidence of a higher bicarbonate concentration. This effect can be seen in the other 4PO, 8PO, and 12PO samples presented in FIG. 25A-25C. No other signals associated with C═O for free CO₂ (124.5 ppm) or carbonic acid (156.5 ppm) were detected at any point of the reaction, suggesting a low concentration as a consequence of continuous consumption of these species [47]. In addition, the carbon signals associated with the chemical composition of DMAPA, and the surface-surface active amine including those from —CH₂—N—, —CH₃—N—, —CH₃—CH— bonds were observed below 80 ppm in the full ¹³C NMR spectra shown in FIG. 26. Therefore, the bicarbonate detection was not interfered by the presence of such compounds.

Contrary to DMAPA, the surface-active amine generated only bicarbonate species during the CO₂ capture process. The built-in surface activity by incorporating PO groups into the primary amino group of DMAPA allowed the formation of a second tertiary amino group in the molecule, preferably producing bicarbonate. However, having two tertiary amines while adding built-in surface activity was not the only booster for bicarbonate generation. The optimal PO level appeared to be the crucial factor (FIG. 9B).

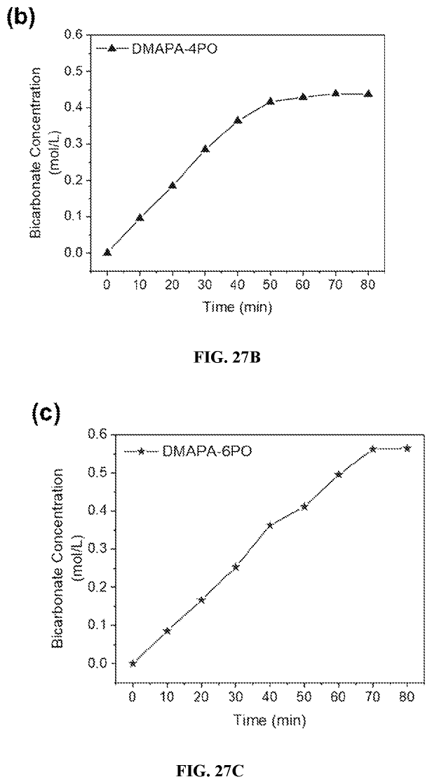

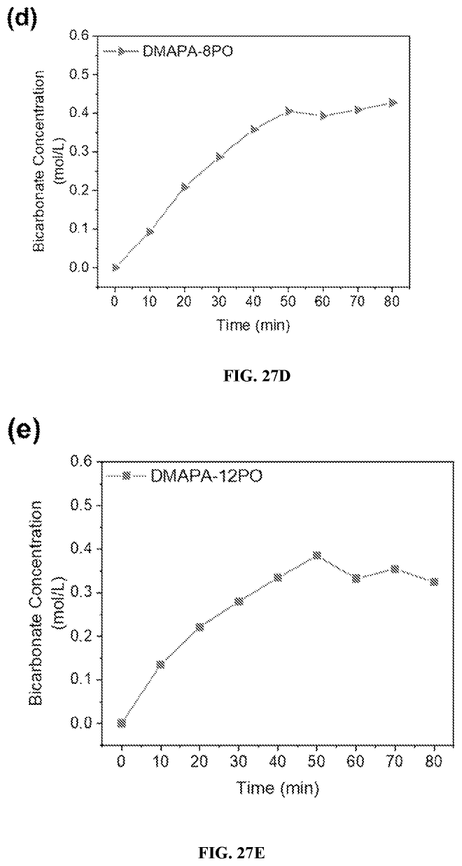

DMAPA-6PO exhibited a superior performance among the different PO levels tested with a final bicarbonate concentration of 0.56 mol/L, which represents an increment in bicarbonate concentration of 54% compared with DMAPA. FIG. 27A-27E shows the histories of bicarbonate generation for DMAPA and DMAPA-xPO. Table 3 shows the final bicarbonate concentrations, the periods required for reaching the equilibrium states, and the average rates of bicarbonate generation. Although the steric effect should be less with DMAPA-4PO than DMAPA-6PO, the CO₂ loading of DMAPA-6PO was approximately 40% greater than that of DMAPA-4PO as shown in Table 1. Likewise, DMAPA-8PO and -12PO resulted in less CO₂ loading than DMAPA-6PO. Also, these larger PO groups negatively affected the surface-active amine performance because of their steric effect [27,44].

Although DMAPA-4PO exhibited more bicarbonate generation than DMAPA, it showed less CO₂ loading capacity than DMAPA. To clarify these points, the CO₂ loading capacity/HCO₃⁻ generation ratio was calculated to be 3.22 for DMAPA, and 2.24 for DMAPA-4PO. It is evident that the primary amino group in DMAPA reacted with CO₂ in combination with the tertiary amino group allowing more CO₂ loading capacity. However, this primary amino group did not significantly contribute to the bicarbonate generation. The CO₂ loading capacity/HCO₃⁻ generation ratio for DMAPA-6PO was calculated to be 2.44, which is greater than DMAPA-4PO and explains that the optimal PO level allowed a higher bicarbonate generation ratio.

TABLE 3
Summarized bicarbonate production parameters.

| | HCO₃_{^{−}} | Time to reach the | |
|---|---|---|---|
| | concentration^{a} | equilibrium state | Average rate |
| Sample | (mol/L) | (min) | (mol/L · min) |
| DMAPA | 0.3664 | 56.90 | 0.0064 |
| DMAPA-4PO | 0.4373 | 47.22 | 0.0092 |
| DMAPA-6PO | 0.5647 | 68.72 | 0.0082 |
| DMAPA-8PO | 0.4272 | 45.31 | 0.0094 |
| DMAPA-12PO | 0.3242 | 46.15 | 0.0070 |

^{a}STD HCO₃_{^{−}} concentration: ±0.002

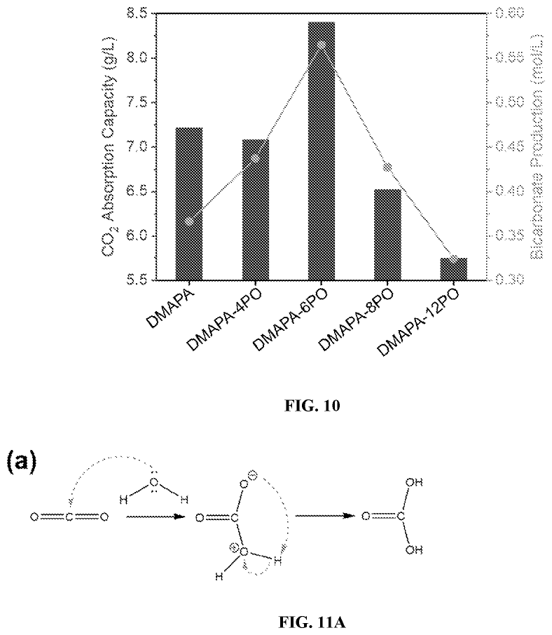

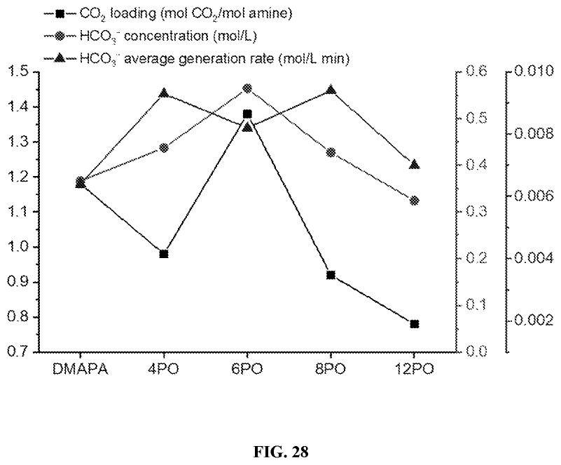

Overall, the incorporation of PO groups enhanced the produced bicarbonate concentration and the bicarbonate generation average rate of DMAPA. Among all DMAPA-xPO samples, DMAPA-6PO showed the longest time to reach the equilibrium state with 68.72 min while generating the greatest bicarbonate concentration. These results suggested that the optimal built-in surface activity in DMAPA-6PO enhanced the bicarbonate generation, as shown in FIG. 28. This observation can be correlated to the central role of the PO groups in the surface-active amine, allowing more CO₂ dissolution in the aqueous amine solution without taking part in the capture and in-situ conversion process at the nitrogen atom in the amino groups. This correlation can be appreciated in FIG. 10. The largest mass of CO₂ absorbed by the amine solution was determined to be 8.4 g/L in DMAPA-6PO, also exhibiting the highest bicarbonate concentration of 0.56 mol/L. In contrast, the lowest bicarbonate amount of 0.32 mol/L was produced by DMAPA-12PO, which also showed the smallest CO₂ absorbed mass (5.75 g/L). Thus, the built-in surface activity represents an effective pathway to enhance the overall CO₂ capture capacity, allowing more CO₂ dissolution that can efficiently be converted into bicarbonate by the tertiary amino groups.

The bicarbonate production was also evaluated at different concentrations of DMAPA-6PO surface-active amine. In addition to 0.25 mol/L as previously tested, 0.05, 0.35, and 0.4 mol/L were evaluated under the same experimental conditions. As shown in Table S2, as the surface-active amine concentration increased, the bicarbonate concentration consistently increased up to 0.88 mol/L using 0.4 mol/L DMAPA-6PO, with an average ratio of 2.17 mol of HCO₃⁻/mol of amine, while the average CO₂ loading ratio was constant around 1.30 mol of CO₂/mol of amine. These results corroborated the remarkable performance of DMAPA-6PO for bicarbonate production while capturing CO₂.

TABLE S2
Summarized results for the overall CO₂ capture performance
of DMAPA-6PO at different concentrations.

| | HCO₃_{^{−}} | HCO₃_{^{−}} loading | CO₂ loading^{b} |
|---|---|---|---|
| Concentration | concentration^{a} | (mol HCO₃_{^{−}}/mol | (mol CO₂/mol |
| (mol/L) | (mol/L) | amine) | amine) |
| 0.05 | 0.10 | 2.00 | 1.25 |
| 0.25 | 0.57 | 2.28 | 1.38 |
| 0.35 | 0.78 | 2.22 | 1.30 |
| 0.4 | 0.88 | 2.20 | 1.27 |

^{a}STD HCO₃_{^{−}} concentration: ±0.002;
^{b}STD CO₂ loading: ±0.02.

The proposed pathways for CO₂ capture and in-situ conversion into bicarbonate are presented in FIG. 11A-11B. Initially, CO₂ gas is dissolved in water which acts as a nucleophile (Lewis base) to produce carbonic acid at a low concentration (FIG. 11A). Then, the surface-active amine takes place as a proton acceptor (Bronsted base) and reacts with CO₂ in the form of carbonic acid, producing an equilibrium state between carbonate and bicarbonate, and protonated amine (FIG. 11B). As the protonation of the surface-active amine increases, the basicity of the amine is consumed and the pH decreases, favoring the bicarbonate production. Along with this pH reduction, carbonate can also deprotonate carbonic acid to produce bicarbonate as a simultaneous reaction (FIG. 11C). Note also that these CO₂ reaction pathways could occur simultaneously at the second nitrogen in the DMAPA-xPO molecule. However, the investigation into mechanisms with the multiple performing nitrogen sites, as well as their production ratio, is out of the scope of this paper. The PO groups and the amino groups play different roles in enhancing the overall bicarbonate generation.

The cost-competitiveness analysis of this bicarbonate pathway must include CO₂ capture as bicarbonate, bicarbonate/surface-active amine separation by a membrane, and the surface-active amine regeneration by deprotonation, among many other factors. A scenario also includes the bicarbonate conversion into formate/formic acid by electrolysis. Such analysis will be performed in the next phase of research considering different parameters, such as the energy consumption for solvent regeneration (conventional CO₂ capture using MEA around 3.5-3.8 GJ/ton CO₂) [50-52].

Nevertheless, Table 4 presents a comparison between CO₂ capture as bicarbonate and conventional CO₂ capture. It shows that the built-in surface activity of DMAPA-6PO exhibited superior CO₂ loading performance in comparison to different systems composed by single amines, amine solution mixture, and amine+surfactant. The bicarbonate generation was proposed and studied for the first time in this research as an alternative to the conventional CO₂ capture technologies.

TABLE 4
Comparative table of different CO₂ capture systems and their performances.

| | | | | CO₂ | | HCO₃⁻ | |
|---|---|---|---|---|---|---|---|
| | | | | loading | | generation | |
| | | Amine | | (mol | CO₂ capture | (mol | |
| | Capture | capture | Added | CO₂/mol | experimental | HCO₃⁻/mol | |
| No. | system | solution | surfactant | amine) | conditions | amine) | Reference |
| 1 | Single | MEA | None | 0.56 | 1 L CO₂/min | No | [53] |
| | | (30 | | | 40-80° C. | reported | |
| | | wt. %) | | | | | |
| 2 | amine | AMP | None | 0.86 | | No | |
| | | (30 | | | | reported | |
| | | wt. %) | | | | | |
| 3 | Single | DMAPA | None | 1.02 | 15 vol % CO₂ | No | [54] |
| | amine | (1 mol/L) | | | 25° C. | reported | |
| 4 | Amine | DMAPA- | None | 1.06 | 12.5 vol. % | No | [37] |
| | solution | NHD- | | | CO₂ | reported | |
| | mixture | H₂O | | | 40° C. | | |
| 5 | Amine + | MEA | Triton | 0.55 | 95 mL | No | [27] |
| | surfactant | (30 | X100 | | CO₂/min | reported | |
| | | wt. %) | (0.28 | | 40° C. | | |
| | | | mmol/L) | | | | |
| 6 | | | CTAB | 0.60 | | No | |
| | | | (0.96 | | | reported | |
| | | | mmol/L) | | | | |
| 7 | Built-in | DMAPA- | None | 1.38 | 50 mL | 2.17 | This |
| | surface | 6PO | | | CO₂/min | | research |
| | active | (0.116 | | | Room temp. | | |
| | amine | mol/L) | | | Ambient | | |
| | | | | | pressure | | |

The technical feasibility of CO₂ capture and in-situ conversion into bicarbonate by using DMAPA with the built-in surface activity by PO-group incorporation that enhanced the bicarbonate generation was demonstrated. The CO₂ capture experiments under ambient conditions and ¹³C NMR spectroscopy analyses revealed that the built-in surface activity enhanced CO₂ solubilization in the aqueous amine solution, improving CO₂ capture and conversion into bicarbonate. Using an optimal PO incorporation (DMAPA-6PO), the bicarbonate generation was improved by 54% compared to DMAPA without the built-in surface activity. CO₂ capture as bicarbonate as studied in this research can be integrated with electrochemical conversion into green carbon chemicals, such as formic acid, toward the carbon neutrality in the energy transition.

### REFERENCES

[1] Liu Z, Deng Z, Davis S J, Giron C, Ciais P. Monitoring global carbon emissions in 2021. Nat Rev Earth Environ 2022; 3:217-9. https://doi.org/10.1038/s43017-022-00285-w.
[2] Wang X, Song C. Carbon Capture From Flue Gas and the Atmosphere: A Perspective. Front Energy Res 2020; 8. https://doi.org/10.3389/fenrg.2020.560849.
[3] Ghiat I, Al-ansari T. A review of carbon capture and utilisation as a CO₂ abatement opportunity within the EWF nexus. J CO₂ Util 2021; 45:101432. https://doi.org/10.1016/j.jcou.2020.101432.
[4] Okoye-Chine C G, Otun K, Shiba N, Rashama C, Ugwu S N, Onyeaka H, et al. Conversion of carbon dioxide into fuels-A review. J CO₂ Util 2022; 62:102099. https://doi.org/10.1016/j.jcou.2022.102099.
[5] Rochelle GT. Conventional amine scrubbing for CO₂ capture. Absorption-Based Post-Combustion Capture of Carbon Dioxide, Elsevier Inc.; 2016, p. 35-67. https://doi.org/10.1016/B978-0-08-100514-9.00003-2.
[6] Wall TF. Combustion processes for carbon capture. Proc Combust Inst 2007; 31:31-47. https://doi.org/10.1016/j.proci.2006.08.123.
[7] Raganati F, Miccio F, Ammendola P. Adsorption of Carbon Dioxide for Post-Capture: A Review. Energy and combustion Fuels 2021; 35:12845-68. https://doi.org/10.1021/acs.energyfuels.1c01618.
[8] Gutiérrez-Sánchez O, Bohlen B, Daems N, Bulut M, Pant D, Breugelmans T. A State-of-the-Art Update on Integrated CO₂ Capture and Electrochemical Conversion Systems. ChemElectroChem 2022; 9. https://doi.org/10.1002/celc.202101540.
[9] Wu H, Li Q, Zhang Y, Qiu M, Liao Y. One-step supramolecular fabrication of ionic liquid/ZIF-8 nanocomposites for low-energy CO₂ capture from flue gas and conversion. Fuel 2022; 322:124175. https://doi.org/10.1016/j.fuel.2022.124175.
[10] Zanatta M, Corvo M C. Ionic liquids and biomass as carbon precursors: Synergistically answering a call for CO₂ capture and conversion. Fuel 2022; 327:125164. https://doi.org/10.1016/j.fuel.2022.125164.
[11] Aghel B, Janati S, Wongwises S, Shadloo MS. Review on CO₂ capture by blended amine solutions. J Greenh Int Gas Control 2022; 119:103715. https://doi.org/10.1016/j.ijggc.2022.103715.
[12] Bui M, Adjiman C S, Bardow A, Anthony E J, Boston A, Brown S, et al. Carbon capture and storage (CCS): The way forward. Energy Environ Sci 2018; 11:1062-176. https://doi.org/10.1039/c7ee02342a.
[13] Liang Z (Henry), Rongwong W, Liu H, Fu K, Gao H, Cao F, et al. Recent progress and new developments in post-combustion carbon-capture technology with amine based solvents. Int J Greenh Gas Control 2015; 40:26-54. https://doi.org/10.1016/j.ijggc.2015.06.017.
[14] Wu S Y, Liu Y F, Chu C Y, Li Y C, Liu C M. Optimal absorbent evaluation for the CO₂ separating process by absorption loading, desorption efficiency, cost, and environmental tolerance. Int J Green Energy 2015; 12:1025-30. https://doi.org/10.1080/15435075.2014.910781.
[15] Gautam A, Kumar Mondal M. Post-combustion capture of CO₂ using novel aqueous Triethylenetetramine and 2-Dimethylaminoethanol amine blend: Equilibrium CO₂ loading-empirical model and optimization, CO₂ desorption, absorption heat, and ¹³C NMR analysis. Fuel 2023; 331:125864. https://doi.org/10.1016/j.fuel.2022.125864.
[16] Li T, Lees E W, Goldman M, Salvatore D A, Weekes D M, Berlinguette C P. Electrolytic Conversion of Bicarbonate into CO in a Flow Cell. Joule 2019; 3:1487-97. https://doi.org/10.1016/j.joule.2019.05.021.
[17] Welch A J, Dunn E, Duchene J S, Atwater H A. Bicarbonate or Carbonate Processes for Coupling Carbon Dioxide Capture and Electrochemical Conversion. ACS Energy Lett 2020; 5:940-5. https://doi.org/10.1021/acsenergylett.0c00234.
[18] Chowdhury F A, Yamada H, Higashii T, Goto K, Onoda M. CO₂ capture by tertiary amine absorbents: A performance comparison study. Ind Eng Chem Res 2013; 52:8323-31. https://doi.org/10.1021/ie400825u.
[19] Bernhardsen I M, Knuutila H K. A review of potential amine solvents for CO₂ absorption process: Absorption capacity, cyclic capacity and pKa. Int J Greenh Gas Control 2017; 61:27-48. https://doi.org/10.1016/j.ijggc.2017.03.021.
[20] Putta K R, Svendsen H F, Knuutila H K. Kinetics of CO₂ Absorption in to Aqueous MEA Solutions Near Equilibrium. Energy Procedia, vol. 114, Elsevier Ltd; 2017, p. 1576-83. https://doi.org/10.1016/j.egypro.2017.03.1288.
[21] Mohamed Mohsin H, Mohd Shariff A, Johari K. 3-Dimethylaminopropylamine (DMAPA) mixed with glycine (GLY) as an absorbent for carbon dioxide capture and subsequent utilization. Sep Purif Technol 2019; 222:297-308. https://doi.org/10.1016/j.seppur.2019.04.029.
[22] Nath D, Henni A. Solubility of carbon dioxide (CO₂) in aqueous solution of 3-(dimethylamino)-1-propylamine (DMAPA). Fluid Phase Equilib 2020; 511:112506. https://doi.org/10.1016/j.fluid.2020.112506.
[23] Zhang R, Yang Q, Yu B, Yu H, Liang Z. Toward to efficient CO₂ capture solvent design by analyzing the effect of substituent type connected to N-atom. Energy 2018; 144:1064-72. https://doi.org/10.1016/j.energy.2017.12.095.
[24] Bajwa G S, Sammon C, Timmins P, Melia C D. Molecular and mechanical properties of hydroxypropyl methylcellulose solutions during the sol: gel transition. Polymer (Guildf) 2009; 50:4571-6. https://doi.org/10.1016/j.polymer.2009.06.075.
[25] Kanokkarn P, Shiina T, Santikunaporn M, Chavadej S. Equilibrium and dynamic surface tension in relation to diffusivity and foaming properties: Effects of surfactant type and structure. Colloids Surfaces A Physicochem Eng Asp 2017; 524:135-42. https://doi.org/10.1016/j.colsurfa.2017.04.043.
[26] Nascimento A E G, Barros Neto E L, Moura M C P A, Castro Dantas T N, Dantas Neto A A. Wettability of paraffin surfaces by nonionic surfactants: Evaluation of surface roughness and nonylphenol ethoxylation degree. Colloids Surfaces A Physicochem Eng Asp 2015; 480:376-83. https://doi.org/10.1016/j.colsurfa.2014.11.003.
[27] Pichetwanit P, Kungsanant S, Supap T. Effects of surfactant type and structure on properties of amines for carbon dioxide capture. Colloids Surfaces A Physicochem Eng Asp 2021; 622:126602. https://doi.org/10.1016/j.colsurfa.2021.126602.
[28] Bryant J J, Lippert C, Qi G, Liu K, Mannel D S, Liu K. Enhanced Carbon Capture through Incorporation of Surfactant Additives. Ind Eng Chem Res 2016; 55:7456-61. https://doi.org/10.1021/acs.iecr.5b04906.
[29] Mohammadpour A, Mirzaei M, Azimi A, Tabatabaei Ghomsheh S M. Solubility and absorption rate of CO₂ in MEA in the presence of graphene oxide nanoparticle and sodium dodecyl sulfate. Int J Ind Chem 2019; 10:205-12. https://doi.org/10.1007/s40090-019-0184-5.
[30] Han S, Jeon S il, Lee J, Ahn J, Lee C, Lee J, et al. Efficient bicarbonate removal and recovery of ammonium bicarbonate as CO₂ utilization using flow-electrode capacitive deionization. Chem Eng J 2022; 431. https://doi.org/10.1016/j.cej.2021.134233.
[31] Wang D X, Wang X L, Tomi Y, Ando M, Shintani T. Modeling the separation performance of nanofiltration membranes for the mixed salts solution. J Memb Sci 2006; 280:734-43. https://doi.org/10.1016/j.memsci.2006.02.032.
[32] Lee G, Li Y C, Kim J Y, Peng T, Nam D H, Sedighian Rasouli A, et al. Electrochemical upgrade of CO₂ from amine capture solution. Nat Energy 2021; 6:46-53. https://doi.org/10.1038/s41560-020-00735-z.
[33] Perez-Gallent E, Vankani C, Sanchez-Martinez C, Anastasopol A, Goetheer E. Integrating CO₂ capture with electrochemical conversion using amine-based capture solvents as electrolytes. Ind Eng Chem Res 2021; 60:4269-78. https://doi.org/10.1021/acs.iecr.0c05848.
[34] Bhattacharya M, Sebghati S, Vercella Y M, Saouma C T. Electrochemical Reduction of Carbamates and Carbamic Acids: Implications for Combined Carbon Capture and Electrochemical CO₂ Recycling. J Electrochem Soc 2020; 167:086507. https://doi.org/10.1149/1945-7111/ab8ed0.
[35] Chen L, Li F, Zhang Y, Bentley C L, Horne M, Bond A M, et al. Electrochemical Reduction of Carbon Dioxide in a Monoethanolamine Capture Medium. ChemSusChem 2017; 10:4109-18. https://doi.org/10.1002/cssc.201701075.
[36] Norouzbahari S, Shahhosseini S, Ghaemi A. Chemical absorption of CO₂ into an aqueous piperazine (PZ) solution: Development and validation of a rigorous dynamic rate-based model. RSC Adv 2016; 6:40017-32. https://doi.org/10.1039/c5ra27869d.
[37] Qiu Y, Lu H, Zhu Y, Liu Y, Wu K, Liang B. Phase-Change CO₂ Absorption Using Novel 3-Dimethylaminopropylamine with Primary and Tertiary Amino Groups. Ind Eng Chem Res 2020; 59:8902-10. https://doi.org/10.1021/acs.iecr.9b06886.
[38] Wang X, Akhmedov N G, Duan Y, Li B. Nuclear magnetic resonance studies of CO₂ absorption and desorption in aqueous sodium salt of alanine. Energy and Fuels 2015; 29:3780-4. https://doi.org/10.1021/acs.energyfuels.5b00535.
[39] Vaidya P D, Kenig E Y. CO₂-alkanolamine reaction kinetics: A review of recent studies. Chem Eng Technol 2007; 30:1467-74. https://doi.org/10.1002/ceat.200700268.
[40] Donaldson T L, Nguyen Y N. Carbon Dioxide Reaction Kinetics and Transport in Aqueous Amine Membranes. Ind Eng Chem Fundam 1980; 19:260-6. https://doi.org/10.1021/1160075a005.
[41] Chen Y, Jiang W, Luo X, Huang Y, Jin B, Gao H, et al. The study of kinetics of CO₂ absorption into 3-dimethylaminopropylamine and 3-diethylaminopropylamine aqueous solution. Int J Greenh Gas Control 2018; 75:214-23. https://doi.org/10.1016/j.ijggc.2018.06.003.
[42] Nath D, Henni A. Kinetics of carbon dioxide (CO₂) with 3-(dimethylamino)-1-propylamine in water and methanol systems using the stopped-flow technique. Ind Eng Chem Res 2020; 59:14625-35. https://doi.org/10.1021/acs.iecr.0c01157.
[43] Karunarathne S S, Eimer D A, Øi L E. Physical Properties of MEA+Water+CO₂ Mixtures in Postcombustion CO₂ Capture: A Review of Correlations and Experimental Studies. J Eng (United Kingdom) 2020; 2020. https://doi.org/10.1155/2020/7051368.
[44] Conway W, Wang X, Fernandes D, Burns R, Lawrance G, Puxty G, et al. Toward the understanding of chemical absorption processes for post-combustion capture of carbon dioxide: Electronic and steric considerations from the kinetics of reactions of CO₂(aq) with sterically hindered amines. Environ Sci Technol 2013; 47:1163-9. https://doi.org/10.1021/es3025885.
[45] Polito A, Folli A, Breitzke B. Multi-purpose surfactants: Low-foaming, fast wetting and biodegradable C11 oxo alcohol alkoxylates. Riv Ital Delle Sostanze Grasse 2008; 85:60-6.
[46] Lv B, Guo B, Zhou Z, Jing G. Mechanisms of CO₂ Capture into Monoethanolamine Solution with Different CO₂ Loading during the Absorption/Desorption Processes. Environ Sci Technol 2015; 49:10728-35. https://doi.org/10.1021/acs.est.5b02356.
[47] Kortunov P V, Siskin M, Baugh L S, Calabro D C. In Situ Nuclear Magnetic Resonance Mechanistic Studies of Carbon Dioxide Reactions with Liquid Amines in Aqueous Systems: New Insights on Carbon Capture Reaction Pathways. Energy & Fuels 2015; 29:5919-39. https://doi.org/10.1021/acs.energyfuels.5b00850.
[48] Kortunov P V., Siskin M, Paccagnini M, Thomann H. CO₂ Reaction Mechanisms with Hindered Alkanolamines: Control and Promotion of Reaction Pathways. Energy and Fuels 2016; 30:1223-36. https://doi.org/10.1021/acs.energyfuels.5b02582.
[49] Yu B, Yu H, Yang Q, Li K, Ji L, Zhang R, et al. Postcombustion Capture of CO₂ by Diamines Containing One Primary and One Tertiary Amino Group: Reaction Rate and Mechanism. Energy and Fuels 2019; 33:7500-8. https://doi.org/10.1021/acs.energyfuels.9b00961.
[50] Gutiérrez-Sanchez O, Bohlen B, Daems N, Bulut M, Pant D, Breugelmans T. A State-of-the-Art Update on Integrated CO₂ Capture and Electrochemical Conversion Systems. ChemElectroChem 2022; 9: e202101540. https://doi.org/https://doi.org/10.1002/celc.202101540.
[51] Sakwattanapong R, Aroonwilas A, Veawab A. Behavior of reboiler heat duty for CO₂ capture plants using regenerable single and blended alkanolamines. Ind Eng Chem Res 2005; 44:4465-73. https://doi.org/10.1021/ie050063w.
[52] Zheng R F, Barpaga D, Mathias P M, Malhotra D, Koech P K, Jiang Y, et al. A single-component water-lean post-combustion CO₂ capture solvent with exceptionally low operational heat and total costs of capture—comprehensive experimental and theoretical evaluation. Energy Environ Sci 2020; 13:4106-13. https://doi.org/10.1039/DOEE02585B.
[53] Kim Y E, Lim J A, Jeong S K, Yoon Y Il, Bae S T, Nam S C. Comparison of carbon dioxide absorption in aqueous MEA, DEA, TEA, and AMP solutions. Bull Korean Chem Soc 2013; 34:783-7. https://doi.org/10.5012/bkcs.2013.34.3.783.
[54] Chen Y, Jiang W, Luo X, Huang Y, Jin B, Gao H, et al. The study of kinetics of CO₂ absorption into 3-dimethylaminopropylamine and 3-diethylaminopropylamine aqueous solution. Int J Greenh Gas Control 2018; 75:214-23. https://doi.org/10.1016/j.ijggc.2018.06.003.

### Example 2: Enhanced CO₂ Capture Using an Amine-Surfactant Mixture

Conventional CO₂ capture using amine solutions have been widely used in CO₂ trapping, in particular monoethanolamine (MEA). The stoichiometry of primary and secondary amine and CO₂ is 2:1 (H. Fu. Frontiers in Chemistry, 7 (2019)). A CO₂ in-situ conversion while capture is a good alternative. And generating bicarbonate can be an efficient way to capture CO₂. CO₂ captured to form K₂CO₃ needs 1.3 MJ/100 mol CO₂ energy input while CO₂ captured to form KHCO₃ only needs 1.0 MJ/100 mol CO₂. Tertiary and sterically hindered amines can directly hydrolyze CO₂ to bicarbonate ions. The stoichiometry of tertiary amine and CO₂ is 1:1 (Berlinguette CP. Electrolytic Conversion of Bicarbonate Solutions to CO at >500 mA cm⁻² and 2.2 V. ChemRxiv. Cambridge: Cambridge Open Engage; 2021). It is an objective to develop an efficient and cost effective carbon dioxide capture system to produce high-valued feedstock for clean energy production and enhanced recovery.

### Experimental

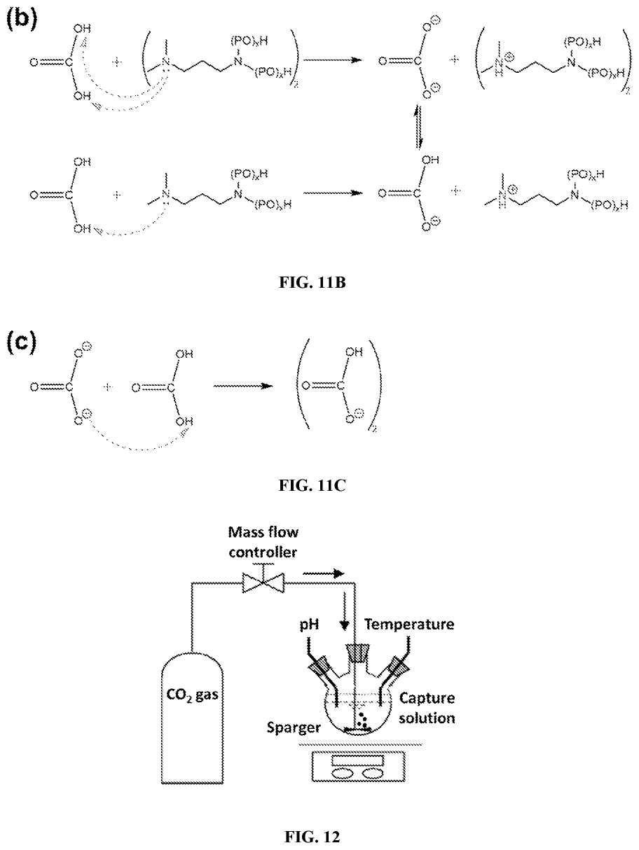

A diagram of the experimental set up is shown in FIG. 12. The capture solution (1 wt %) includes monoethanolamine (MEA) (control), methyl diethanolamine (MDEA), 2-amino-2methyl-1-propanol (AMP). An additive (1 wt %) is added including nonionic surfactant (2-ethylhexanol-7PO-8EO). The set up includes a CO₂ flow rate: 50 mL/min. The CO₂ capture amount is determined by determining the mass difference before and after the test. A ¹³C NMR is performed and [CH₃)₄N⁺Cl⁻] is used as internal standard.

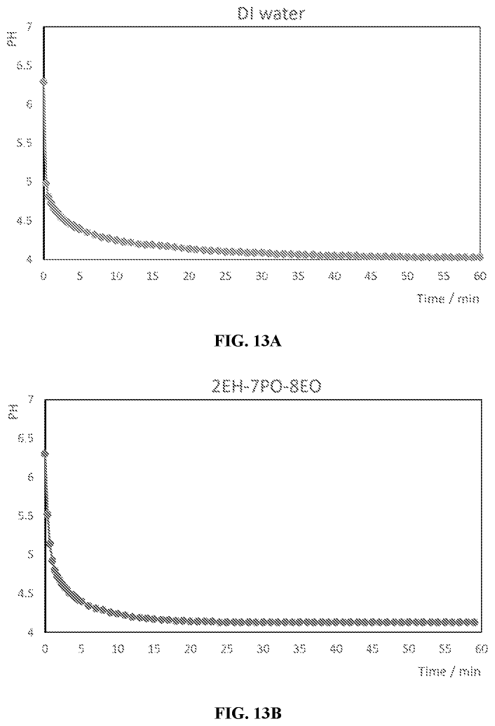

The addition of surfactant on DI water enhanced CO₂ capture amount by 2.5 times and speeded up CO₂ capture by 1.5 times as shown in FIGS. 13A-13B and Table 5.

TABLE 5

| | | Time for |
|---|---|---|
| Capture solution | CO₂ captured mass (g) | constant pH (min) |
| DI water | 0.2 | 45 |
| 2EH-7PO-8EO | 0.5 | 30 |

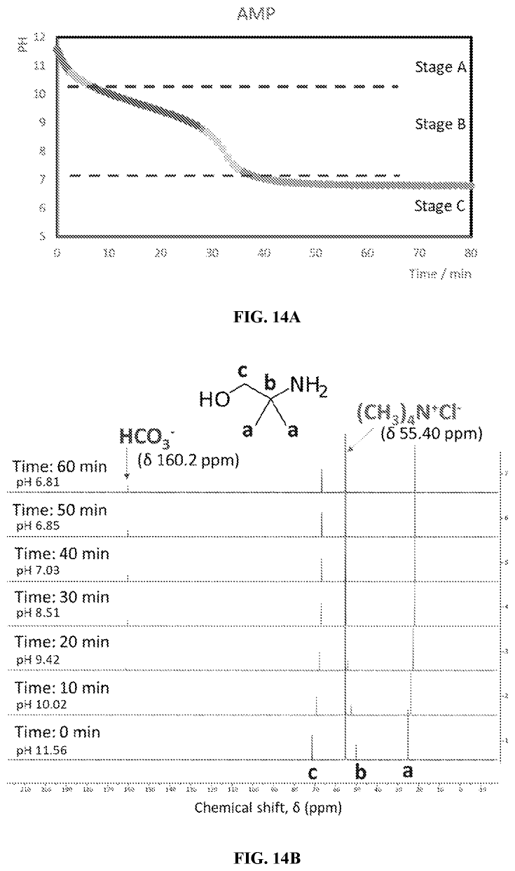

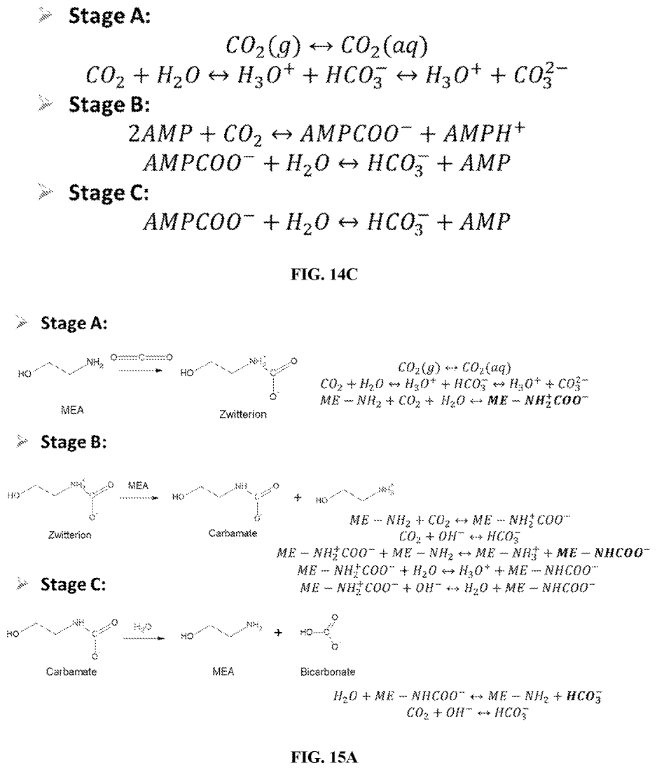

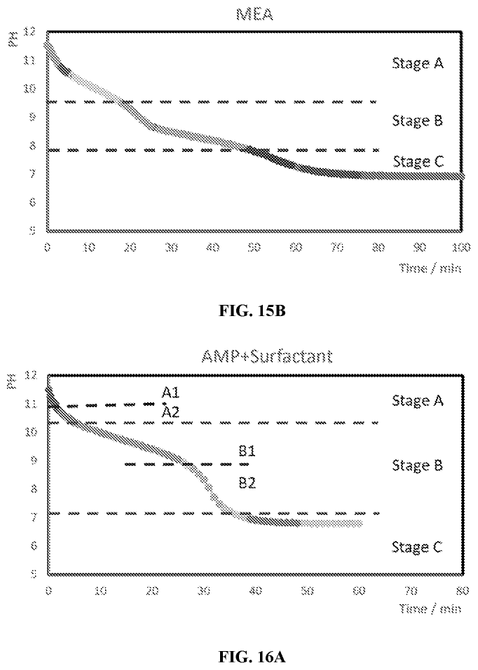

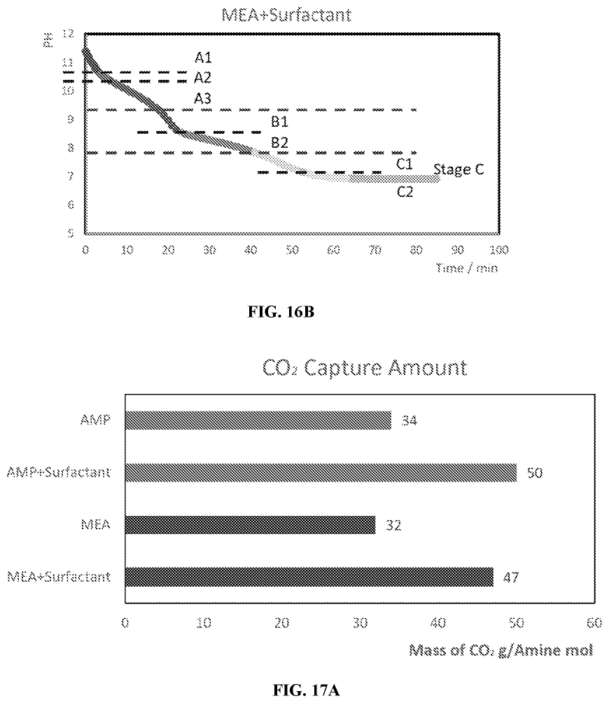

AMP effects on CO₂ capture as shown in FIGS. 14A-14C (D. Tong et al. 2013, Brent J. Sherman et al. 2016). MEA effects on CO₂ capture are shown in FIGS. 15A-15B (B. Lv. Environ. Sci. Technol. 49 (2015) 10728-10735). The addition of surfactant on amine solutions enhanced the CO₂ capture amount by 1.45 times (AMP) and 1.49 times (MEA) and speeded up CO₂ capture by 1.35 times (AMP) and 1.31 times (MEA). For each sub-stages, a linear relationship between pH and time was fitted. The slope of each sub-stage was defined as the kinetic reaction rate (K). See FIGS. 16A-16B and Table 6.

TABLE 6
Kinetic reaction rate increment by adding surfactant.

| | Stage A | | | Stage B | | Stage C | |
|---|---|---|---|---|---|---|---|
| Solution | A1 | A2 | A3 | B1 | B2 | C1 | C2 |
| AMP | 4% | 14% | — | −1% | 12% | 10% | — |
| MEA | −7% | −18% | 7% | 40% | 16% | 16% | 7% |

*The kinetic reaction rate K_{B2} was defined as the bicarbonate generation rate.

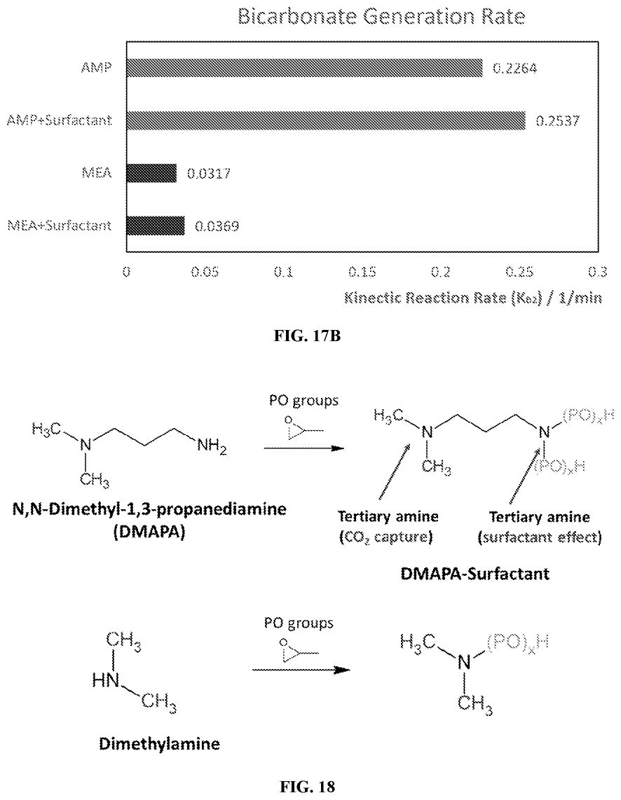

In summary, the addition of surfactant improved the total amount of CO₂ captured by 1.47 times (AMP) and 1.5 times (MEA) (FIG. 17A). The addition of surfactants also speeded up kinetic reaction rate, especially for bicarbonate generation stage (B2) by 1.12 times (AMP) and 1.16 times (MEA) (FIG. 17B).

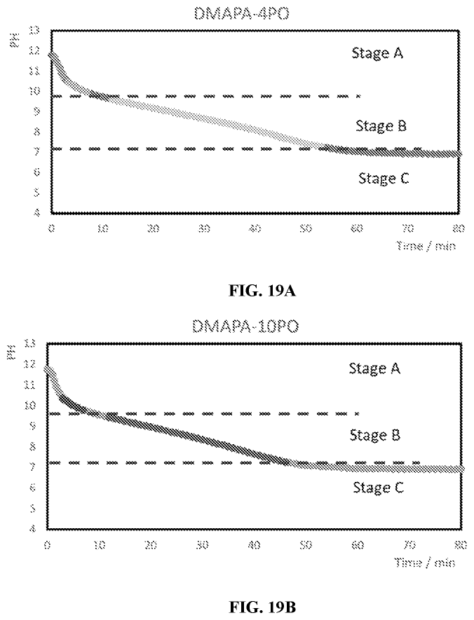

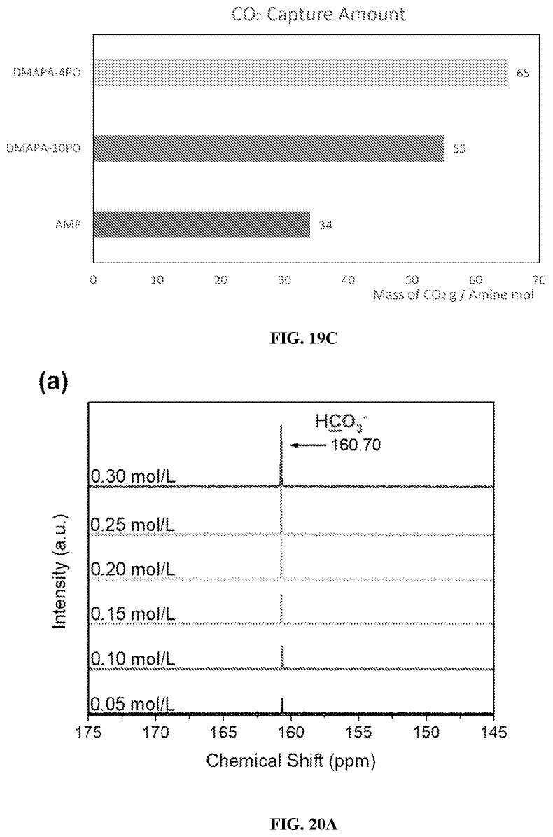

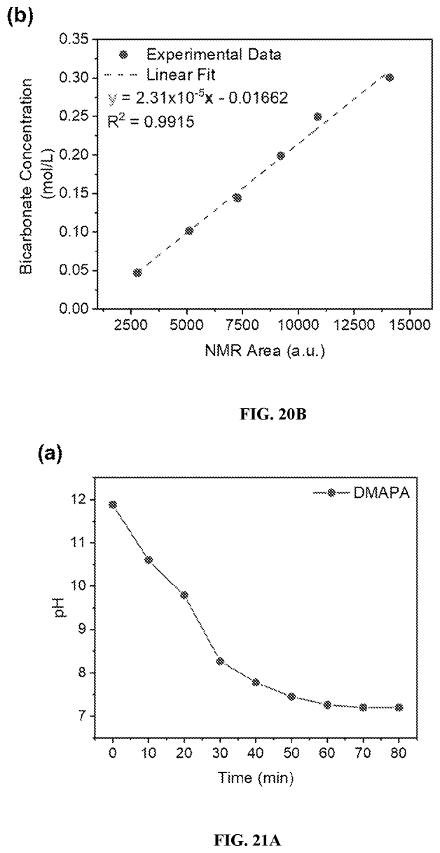

Surface active amines are shown in FIG. 18, initial results on DMAPA-Surfactant are shown in FIGS. 19A-19C. Compared to DMAPA-4PO the kinetic reaction rate for DMAPA-10PO was increased, especially increased 1.13 times at bicarbonate generation stage (stage B) and the CO₂ capture amount for DMAPA-10PO was enhanced by 1.18 times. Compared with AMP the CO₂ capture speed for DMAPA-surfactant cases was reduced by 1.07 times for both cases and the CO₂ capture amount is enhanced by 1.91 times (DMAPA-4PO) and 1.62 times (DMAPA-10PO).

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

1. A method for capturing an acidic gas from a gas stream, the method comprising:
contacting the gas stream with a capture solution comprising a gas capture agent and a surfactant.

2. The method of claim 1, wherein the surfactant exhibits an HLB value of from 6 to 15, such as from 6 to 8, from 6 to 10, from 6 to 12, from 8 to 10, from 8 to 12, from 8 to 15, from 10 to 12, from 10 to 15, or from 12 to 15.

3. The method of claim 1, wherein the surfactant comprises a non-ionic surfactant.

4. The method of claim 1, wherein the surfactant comprises an alcohol alkoxylate.

5. The method of claim 4, wherein the alcohol alkoxylate comprises at least one propoxy segment.

6. The method of claim 1, wherein the surfactant is defined by Formula I 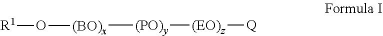
wherein
BO represents —CH₂—CH(ethyl)-O— and/or —CH₂CH(—)CH(O—)CH₂—;
PO represents —CH₂—CH(methyl)-O—;
EO represents —CH₂—CH₂—O—;
R¹ represents a C₈-C₃₂ alkyl group, a C₈-C₃₂ alkenyl group, a C₈-C₃₂ alkynyl group, an aryl group, or an alkylaryl group;
Q is hydrogen;
x is an integer from 0 to 10;
y is an integer from 0 to 40; and
z is an integer from 0 to 40,
with the proviso that at least one of x, y, and z is greater than 0.

7. The method of claim 1, wherein the surfactant is defined by Formula IA 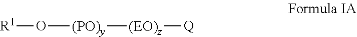
wherein
BO represents —CH₂—CH(ethyl)-O— and/or —CH₂CH(—)CH(O—)CH₂—;
PO represents —CH₂—CH(methyl)-O—;
EO represents —CH₂—CH₂—O—;
R¹ represents a C₈-C₃₂ alkyl group, a C₈-C₃₂ alkenyl group, a C₈-C₃₂ alkynyl group, an aryl group, or an alkylaryl group;
Q is hydrogen;
y is an integer from 1 to 40; and
z is an integer from 1 to 40.

8. The method of claim 1, wherein the surfactant is present in the capture solution in an amount of from 0.5% to 5% by weight, based on a total weight of the capture solution.

9. The method of claim 1, wherein the gas capture agent comprises an amine gas capture agent.

10. The method of claim 9, wherein the amine gas capture agent comprises a monoamine, a diamine, or a polyamine.

11. The method of claim 9, wherein the amine gas capture agent comprises a tertiary amine.

12. The method of claim 9, wherein the amine gas capture agent comprises a sterically hindered amine.

13. The method of claim 1, wherein the gas capture agent comprises methylamine, ethylamine, propylamine, iso-propylamine, butylamine, iso-butylamine, sec-butylamine, tert-butylamine, pentylamine, iso-pentylamine, sec-pentylamine, tert-pentylamine, hexylamine, iso-hexylamine, sec-hexylamine, tert-hexylamine, ethylenediamine, (2-methylbutyl)amine, 2-aminopentane, 3-(tert-butoxy)propylamine, 2-amino-6-methylheptane, 1-ethylpropylamine dimethylamine, diethylamine, dipropylamine, dibutylamine, dipentylamine, dihexylamine, N-ethylmethylamine, N-isopropylmethylamine, N-butylmethylamine, N-ethylisopropylamine, N-tert-butylmethylamine, N-ethylbutylamine, 3-isopropoxypropylamine, chloro(diethylamino)dimethylsilane, 2,2′-(ethylenedioxy)bis(ethylamine), 1,3-bis(chloromethyl)-1,1,3,3-tetramethyldisilazane, N-tert-butylisopropylamine, N,N-diethyltrimethylsilylamine, di-sec-butylamine, trimethylamine, triethylamine, tripropylamine, tributylamine, dimethylpropylamine, diethylpropylamine, N,N-diisopropylmethylamine, N-ethyldiisopropylamine, N,N-dimethylethylamine, N,N-diethylbutylamine, 1,2-dimethylpropylamine, N,N-diethylmethylamine, N,N-dimethylisopropylamine, 1,3-dimethylbutylamine, 3,3-dimethylbutylamine, N,N-dimethylbutylamine, tetramethylethylenediamine (TMEDA), tetraethylmethanediamine (TEMDA), tetramethylmethanediamine (TMMDA), tetramethyl-1,3-diaminopropane (TMPDA) or triethylamine (TEA), monoethanolamine (MEA), diethanolamine (DEA), N-methyldiethanolamine (MDEA), 2-diethylaminoethanol (DEAE), 3-(diethylamino)-1,2-propanediol (DAPD) or 2-amino-2-methyl propan-1-ol (AMP), piperazine (PZ), morpholine, piperidine, pyrrolidine, 1,8-diazabicyclo[5.4.0]undec-7-ene (DBU), glycine, or a combination thereof.

14. The method of claim 1, wherein the gas capture agent is present in the capture solution in an amount of from 0.5% to 5% by weight, based on a total weight of the capture solution.

15. A method for capturing an acidic gas from a gas stream, the method comprising:
contacting the gas stream with a capture solution comprising a surface-active gas capture agent.

16.-28. (canceled)

29. The method of claim 1, wherein the capture solution comprises an aqueous solution.

30. The method of claim 1, wherein the gas stream comprises one or more gases chosen from a flue gas, a natural gas, a hydrogen gas, and a synthesis gas.

31. The method of claim 1, wherein the acidic gas is chosen from one or more of CO₂, H₂S, COS, CS₂, and mercaptans.

32. The method of claim 1, wherein the acidic gas comprises CO₂.

33. The method of claim 1, further comprising subsequently routing the capture solution through a stripper.
